(19) United States
(12) Patent Application Publication
(10) Pub. No.: US 2011/0066971 A1
(43) Pub. Date: Mar. 17, 2011

(54) METHOD AND APPARATUS FOR PROVIDING APPLICATION INTERFACE PORTIONS ON PERIPHERAL COMPUTING DEVICES

(76) Inventors: Babak Forutanpour, Carlsbad, CA (US); Ronen Stern, San Diego, CA (US); Joel Linsky, San Diego, CA (US); Kurt W. Abrahamson, Carlsbad, CA (US)

(21) Appl. No.: 12/558,936

(22) Filed: Sep. 14, 2009

(51) Int. Cl. G06F 3/048; G06F 15/16; G06F 3/14

(52) U.S. Cl. 715/788; 715/806; 709/217; 715/864

(57) ABSTRACT

The methods and devices enable displaying image portions generated on a first computing device on a second computing device. A master helper app on the first device receives user content selections and computes bounding boxes on each. The master helper app may expand the system frame buffer to hold the selected content and cause the windows manager to direct applications to draw contents into the expanded frame buffer. The master helper app may invoke a slave helper app on the second device to receive the frame buffer contents. The slave helper app stores the received display data in a frame buffer so the image is displayed. Resizing, blending and partitioning processing of display content can be accomplished on either the first or second devices or on a third proxy device. Keystrokes on the second device can be translated into commands executed on the first device.

### FIELD OF THE INVENTION

The present invention relates generally to computer graphical user interfaces, and more particularly to methods and apparatus for providing application interface portions on peripheral computer devices.

### BACKGROUND

Computing devices with graphical user interfaces, such as computer workstations and cellular telephones, provide users with applications having a graphical interface. Such a graphical interface permits images to be displayed by applications and Internet web pages. However, current applications can display images only on displays coupled to the computer on which the application is running.

### SUMMARY

The various aspects provide a method for displaying selected portions of a display image generated on a first computing device implementing a master helper application on a display of a second computing device implementing a slave helper application that includes reformatting a display image generated by an application running on the first computing device to fit the display of the second computing device and storing the reformatted display image to a frame buffer of the first computing device as a hidden window object under direction of the master helper application, transmitting the hidden window object display data to the second computing device via communication between the master helper application and the slave helper application, storing the hidden window object display data in a frame buffer of the second computing device under direction of the slave helper application, and rendering the display on the second computing device using the hidden window object display data stored in the frame buffer of the second computing device.

The aspect methods may include reformatting a display image by directing an application running on the first computing device to paint a portion of the application's display image to the frame buffer of the first computing device as a hidden window object, and reformatting the hidden window object display data to fit the display of the second computing device. The aspect methods may include receiving a user input on the first computing device indicating a selection of the display image to be displayed on the second computing device and reformatting the selected portions for display on the second computing device. Reformatting the hidden window object display data to fit the display of the second computing device may be accomplished in the first computing device, and transmitting the hidden window object display data to the second computing device may include transmitting resized hidden window object display data to the second computing device. Alternatively, reformatting the hidden window object display data to fit the display of the second computing device may be accomplished in the second computing device.

In a further aspect, the methods may include transmitting the hidden window object display data to a third computing device and reformatting the hidden window object display data to fit the display of the second computing device in the third computing device, and transmitting resized hidden window object display data from the third computing device to the second computing device. Reformatting the hidden window object display data may include processing the hidden window object display data so that the data will generate the display image compatible with the display of the second computing device.

In a further aspect method, the first computing device may receive display data from the second computing device, and reformat the hidden window object display data to generate a single blended display image or a side-by-side display compatible with the display of the second computing device.

The transmission of display data may be accomplished via a wireless data link established between the first and second computing devices, such as a Bluetooth®t wireless data link.

A further aspect method may include receiving a user input on the second computing device, communicating information regarding the received user input to the first computing device, correlating the communicating information regarding the received user input to the portion of the application's display image to determine a corresponding user input to the application operating on the first computing device, and communicating the corresponding user input to the application operating on the first computing device.

A further aspect method may include notifying the second computing device that portions of a display image may be transmitted to it, prompting a user of the second computing device to confirm agreement to receive the portion of the display image, determining whether the user of the second computing device confirmed agreement to receive the portion of the display image, and receiving the hidden window object display data in the second computing device if it is determined that the user of the second computing device confirmed agreement to receive the portion of the display image.

A further aspect method may include providing characteristics of the display of the second computing device to the application running on the first computing device, and receiving a display image from the application into the frame buffer in a format compatible with the display of the second computing device. In this aspect the image may be resized for a display that is larger than a display of the first computing device.

A further aspect method may include transmitting the hidden window object display data from the second computing device to a third computing device, storing the received hidden window object display data in a frame buffer of the third computing device, and rendering a display on the third computing device using the hidden window object display data stored in the frame buffer of the third computing device.

A further aspect includes a computing device configured to implement the various methods described above. A further aspect includes a communication system including multiple communication devices configured to implement the various methods described above as a system. In an aspect a programmable processor in each computing device is configured with processor-executable instructions to perform processes of the foregoing methods. In another aspect, the computing devices comprise means for accomplishing the processes of the foregoing methods.

Various aspects also include a computer program product that includes a computer-readable storage medium on which is instructions for performing the processes of the foregoing methods are stored.

### BRIEF DESCRIPTION OF THE DRAWINGS

The accompanying drawings, which are incorporated herein and constitute part of this specification, illustrate exemplary aspects of the invention, and, together with the general description given above and the detailed description given below, serve to explain features of the invention.

FIG. 1 is a system block diagram of a communication system suitable for use with the various aspects.

FIG. 2A is an example application display presented on a mobile device.

FIG. 2B is an example of display presented on a wristwatch device that includes portions of the application display shown in FIG. 2A.

FIG. 3A is an example of a webpage presented on a web browser screen image.

FIG. 3B is an example of display presented on a digital picture frame device that includes a portion of the webpage display shown in FIG. 3A.

FIG. 4 is a software component block diagram according to an aspect.

FIG. 5 is a software component block diagram according to another aspect.

FIG. 6 is a software component block diagram according to another aspect.

FIG. 7 is a software component block diagram according to another aspect.

FIG. 8 is a process flow diagram of a method for porting display mashups to a peripheral device according to an aspect.

FIG. 9 is an illustration of a user interface interaction with a mobile device having a touchscreen display according to an aspect.

FIG. 10 is a process flow diagram of a method porting portions of an application display to a peripheral device according to an aspect.

FIG. 11 is a process flow diagram of a method porting portions of an application display to a peripheral device according to another aspect.

FIG. 12 is a process flow diagram of a method porting portions of an application display to a peripheral device according to an aspect.

FIG. 13 is a software component block diagram according to another aspect.

FIG. 14 is a process flow diagram of a method porting portions of an application display to a peripheral device according to an aspect.

FIG. 15 is a software component block diagram according to another aspect.

FIG. 16 is a component block diagram of a mobile device suitable for use with the various aspects.

FIG. 17 is a circuit block diagram of an example computer suitable for use with the various aspects.

FIG. 18 is a component block diagram of an example wristwatch peripheral device suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In this description, the term “exemplary” is used herein to mean “serving as an example, instance, or illustration.” Any implementation described herein as “exemplary” is not necessarily to be construed as preferred or advantageous over other implementations.

As used herein, the term “mobile device” is intended to encompass any form of programmable computing device as may exist, or will be developed in the future, which implements a programmable processor and display, including, for example, cellular telephones, personal data assistants (PDA's), palm-top computers, laptop and notebook computers, wireless electronic mail receivers (e.g., the Blackberry® and Treo® devices), multimedia Internet enabled cellular telephones (e.g., the Blackberry Storm®), and similar personal electronic devices which include a wireless communication module, processor, and memory.

The various aspects provide methods and devices for displaying selected portions of an image generated by an application running on a first computing device to be displayed in a view window of a second computing device which is also referred to herein as a peripheral computing device. For ease of reference, the first computing device generating a display image is referred to as the “master device,” while the second or peripheral computing device that receives and displays the image is referred to as the “slave device.”

The various aspects may utilize specialized applications to help in the sharing and communication of display buffers from the master and slave devices. For ease of reference, such specialized applications are referred to herein as “helper apps.” A master helper app may be implemented on the master device to assist in preparing display images and buffers for communicating display data to the slave device, and a slave helper app may be implemented on the slave device to assist in receiving the display buffers and rendering the associated images.

The master helper app running on the master device that has privileged access to the low-level subsystem of the master device is included within the operating system. This master helper app allows a user to initiate a display sharing processed by providing a user input, such as a hot key or mouse click, on the master device. The master helper app allows a user to select one or more regions of a content displayed on the master device for sharing on a slave device. If the master device has a touchscreen display, the user may select regions of content for sharing on the server device using a special gesture. The master helper app may enable the user to select multiple regions of the displayed content. The master helper app may compute bounding boxes on each of the selected regions of content. The master device may discover slave devices that are within communication with the master device, such as via a Bluetooth® communication link, and enable a user to select a particular slave device for receiving the selected regions of content for display. Once the slave device is identified, the master helper app may expand the device's system frame buffer enough to hold the identified regions of content. The master helper app may ask the windows manager for the application that is displaying content within the bounding box and ask the windows manager to direct that application to draw its entire contents into the newly allocated frame buffer. The user may be prompted to indicate whether the application should still draw into the primary buffer for display on the master device. The window manager may copy the display output from the application into one or both of the primary buffer or the newly allocated frame buffer. The master helper app makes a connection to the slave device and invokes the slave helper app running on the slave device to accomplish the communication of selected regions of content.

The user may be provided the option of displaying the selected regions of content on the slave device in one of three modes: taking over the entire display; overlaying the selected regions of content over the slave device's current display content (with a slider for defining the level of transparency); and fitting both contents on the same screen.

The master device may query the slave device about its display and processing capabilities to determine how the processing should proceed. In some implementations, the slave device will have less processing power and memory than the master device, in which case the master device may be used to conduct much of the image processing. In other implementations, the slave device will have more processing power and memory than the master device, in which case the master device will send the image data to the slave device for reprocessing.

The processing that is performed may depend upon the display mode selected by the user for the slave device. In the case where the display content provided by the master device will occupy the entire display of the slave device (i.e., “takeover”), the master helper app on the master device may obtain the selected regions of content from the master device frame buffer, re-size that content in heap memory to fit the display size of the slave device, and send the re-sized data to the slave helper app which accepts the data and stores it in the slave device's frame buffer for display.

In the case where the display content provided by the master device will overlay content of the slave device (i.e., “overlay mode”), the master helper app on the master device requests the slave device to provide its current frame buffer content. This display information provided by the slave device is then blended with the selected regions of content of the master device display in the master device frame buffer, after which the master helper app sends the resulting display data to the slave helper app, which puts the data in the slave device's frame buffer for display.

In the case where the display content provided by the master device will be presented on the slave device display next to slave device display content (i.e., “fit both mode”) and the master device has more processing power, the master helper app requests the slave device to provide its current frame buffer contents, which it receives and resizes to provide room for the selected regions of content of the master device display. The master helper app also resizes the selected regions of content of the master device display so that both displays can fit side by side within the slave device's display area. The combination of the two re-sized displays are then sent to the slave helper app which puts the data in the slave device's frame buffer for display.

In addition to moving a portion of a display from the master device to the slave device, the slave device can accept user inputs related to the displayed content, which can be passed back to the application running on the master device to enable a user interface capability on the slave device. Keystrokes received on the slave device are provided to the master helper app on the master device which interprets them as input commands and passes the appropriate keystroke information to the application generating the display via the window manager. The running application can accomplish the appropriate processing and render display contents in the secondary frame buffer as normal, which will result in a corresponding display on the slave device.

In an aspect, the master helper app and slave helper app can run concurrently on a single computing device. This aspect enables two computing devices to operate with a third computing device referred to as a “proxy device” which may be used to perform some of the processing associated with resizing, fitting, and/or blending of the various display contents. In an aspect, such a proxy device may be used only if it has the processing power, memory and data connection speed necessary to handle the display processing transaction. When a proxy device is used for accomplishing some of the display processing, both the master device and the slave device send the selected content to the proxy device for reprocessing. The proxy device performs the required display image processing and sends the processed data to the slave device for display.

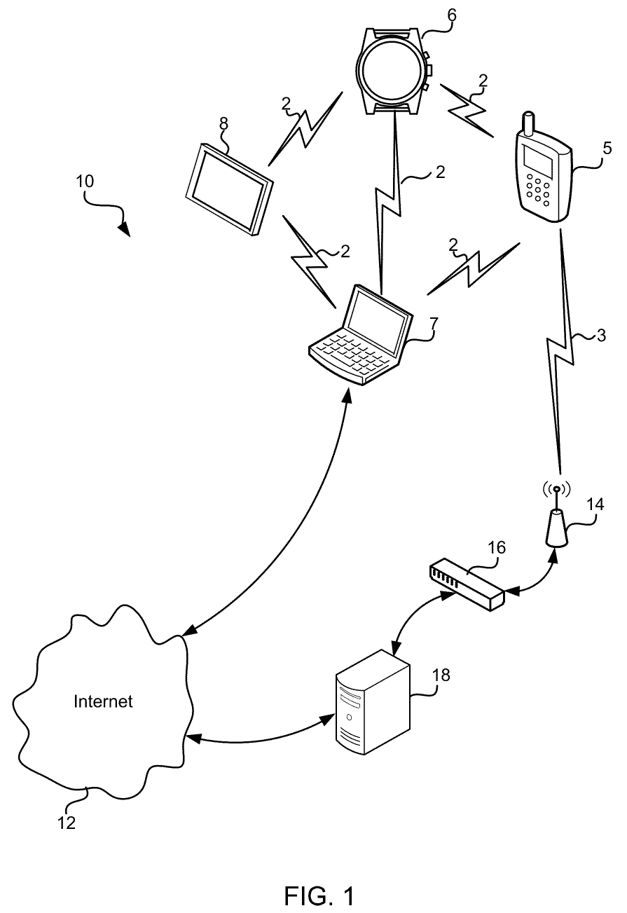

The various aspects may be employed in a variety of wired and wireless communication networks. By way of example, FIG. 1 shows a wireless communication network 10 employing wireless and cellular data communication links suitable for use with the various aspects. The communication network 10 may include a variety of computing devices, such as a mobile device 5 with a graphical user interface. The mobile device 5 may be configured with a network antenna and transceiver for transmitting and receiving cellular signals 3 from/to a cellular base site or base station 14. In this example network 10, the base station 14 is a part of a cellular network that includes elements required to operate the network, such as a mobile switching center (MSC) 16. In operation, the MSC 16 is capable of routing calls and messages to and from the mobile device 5 via the base station 14 when the mobile device 5 is making and receiving cellular data calls. The mobile device 5 may also be capable of sending and receiving data packets through a gateway 18 that connects the cellular network to the Internet 12.

The mobile device 5 may also be configured with an antenna and transceiver for transmitting and receiving personal area network signals 2 capable of establishing a personal area network with other computing devices, such as a Bluetooth®t wireless communication link. The mobile device 5 may use such a personal area network to connect with other computing devices, such as a laptop computer 7, an electronic wrist watch with a programmable display 6, and a digital picture frame 8. Some of the computing devices like a laptop computer 7 may be configured with hardware and network connections for establishing a connection to the Internet 12, such as a wired or wireless local area network connection.

Use of the various aspects with the computing devices in the communication network 10 may enable a number of useful applications. For example, users can run an application on one computing device, such as a mobile device 5 or laptop computer 7, and transmit some or all of the application display via the personal area network transmissions 2 to a more convenient display device, such as a digital picture frame 8 or an electronic wristwatch display 6. As another example, a user may receive electronic mail on a mobile device 5 via a cellular wireless network transmission 3, and be able to view an indication that the e-mail has been received or view portions of the e-mail itself on an electronic wristwatch display 6, with the display information communicated by the personal area network transmissions 2. As a further example, a user may access content from a website on the Internet 12 via a wired connection (as illustrated for the laptop computer 7), or via a wide area wireless network transmission 3 (as illustrated for the mobile device 5), and may elect to display at least portions of that content on a digital picture frame 8 or an electronic wristwatch display 6, with the display information communicated by the personal area network transmissions 2. Thus, a user could access a streaming video content source on the Internet 12 via a personal computer 7 and present the video images on a digital picture frame 8.

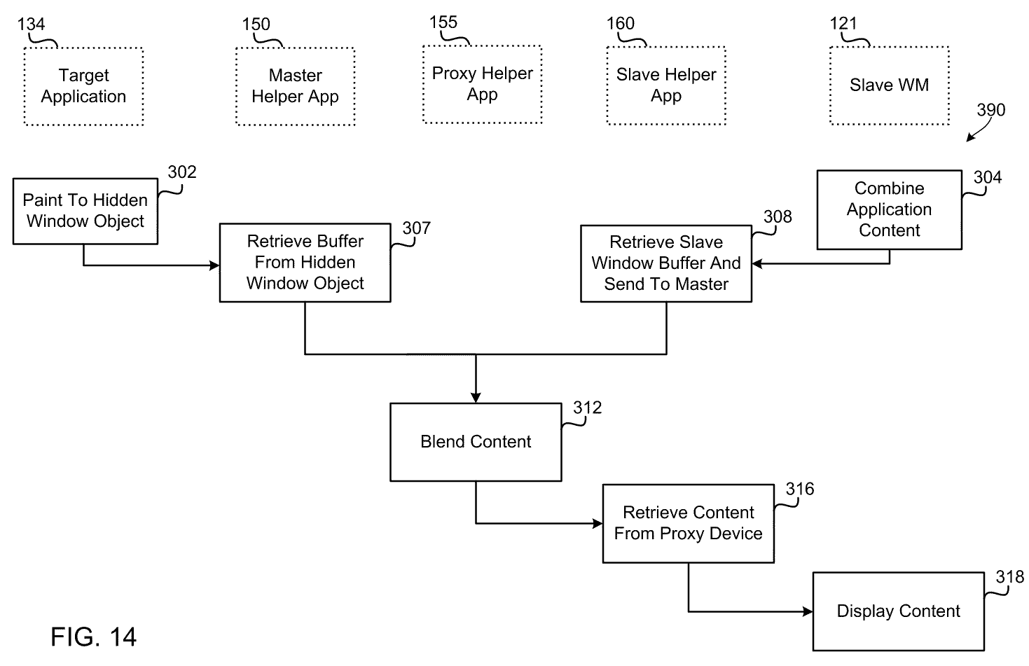

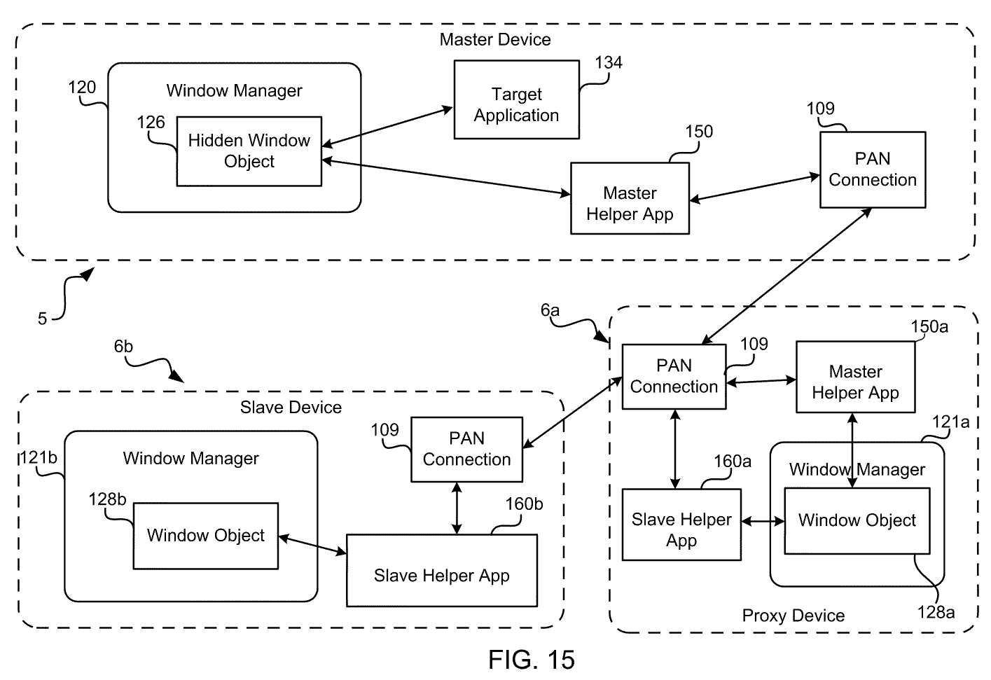

As described more fully below with reference to FIGS. 14 and 15, an aspect enables displaying portions of image content generated on a first device on the display of a second device using processing power of a third device. This is enabled by the communication network 10 which may allow the computing devices, such as a mobile device 5, an electronic wristwatch 6, and a laptop computer 7, to exchange display data via personal area network transmissions 2. For example, a user receiving display content on a mobile device 5 via a wide area wireless network transmission 3 may be able to port some wall of the display to an electronic wristwatch 6 by using a laptop computer 7 to accomplish some of the image reformatting necessary to fit within the size of the electronic wristwatch display 6, with the data communications between the three devices being carried by the personal area network transmissions 2.

The various aspects may make use of components that are found in various computing devices configured with graphical user interfaces (GUI). As is well known in the computing arts, GUI environments may make use of various pixel arrays for displaying graphics. Such arrays may generally be referred to as buffers, rasters, pixel buffers, pixel maps, or bitmaps. The first GUI environments utilized a single pixel buffer for displaying the output of an application on a display (e.g., a monitor). Such a pixel buffer may be referred to as a frame buffer. In a GUI environment with a single frame buffer, applications may copy data corresponding to pixel color values into the frame buffer, and the monitor may color the screen according to the data stored in the frame buffer. A frame buffer that is accessed by a display driver in order to update the display may be referred to as a system frame buffer. Pixel buffers, including system frame buffers, often make use of multiple arrays through techniques known as double buffering and triple buffering, but the various buffers may still be referred to as a single buffer.

Modern GUI environments may allow multiple graphical applications to access the same display through a concept called windowing. In such an environment, the operating system may hide the system frame buffer from most applications. Instead of accessing the system frame buffer directly, each application may send their display output to a pixel buffer, which may be referred to as a window buffer. The window buffer may be read by the window manager, an application that is part of a windowed GUI environment. The window manager may determine where, if anywhere, within the system frame buffer the contents of the window buffer should be stored. For example, a windowed GUI may have three applications running within windows, for example. If the window for application A is minimized, its output (i.e., the contents of its window buffer) may not be displayed and the contents of its window buffer may be ignored by the window manager. If the windows for application B and application C are both active on the desktop, but the window for application B partially occludes the window for application C (i.e., window B partially overlaps window C), the window manager may copy the entire contents of the window buffer of application B into the system frame buffer, while only copying part of the window buffer of application C into the system frame buffer.

In addition to displaying the various windows, a window manager may also provide information to applications about the windows. For example, a window manager may notify an application when its window is minimized, resized, or hidden from view. The window manager may also provide information to the window such as the size or location of the window. Further, a window manager may notify an application when the user interacts with the application window (e.g., clicking a mouse button while the mouse pointer is positioned within the window for that application).

The various objects (e.g., the various pixel buffers and the various widgets) that make up a windowed application may be considered child objects of the instance of the windowed application. Generally, a simple application such as a text editor will correspond to a single operating system process, which may include multiple threads. Some more complex applications will have multiple processes that appear to the user as one application. As would be understood by those in the arts, the processes may be linked together as parent and child processes.

The foregoing description is only one example method for generating displays in a windowed GUI environment. Many window managers, particularly non-compositing window managers, do not make use of a window buffer for each window. Such window managers may explicitly ask the active windows for their output and notify the occluded windows that their output is not needed. Further, windows may not store a buffer for each window element. Rather, some window elements may use vector graphics or a similar method of creating pixel images using an algorithm. Some window objects may not dedicate a portion of memory to storing the pixel output of its various subcomponents. Rather, when asked for their pixel output, such window objects will simply aggregate the pixel output of the various subcomponents, which may or may not be based on a dedicated pixel array stored in memory. Therefore, as used herein, a pixel buffer (e.g., a window buffer, a view window buffer, or a render buffer) means either a dedicated portion of memory for storing pixel values, or a temporary portion of memory for storing pixel values corresponding to the result of a function call.

Computing devices configured with windowed GUI environments are not limited to desktop computers. Mobile devices often include GUI environments with a window manager. GUI environments with a window manager may be part of virtually any computing device with an integrated display or a connection capable of carrying a video signal, such as an HDMI output or simply a network interface. Such devices may include electronic wristwatches, video goggles, digital picture frames, televisions, DVD players, and set-top cable boxes, to name just a few.

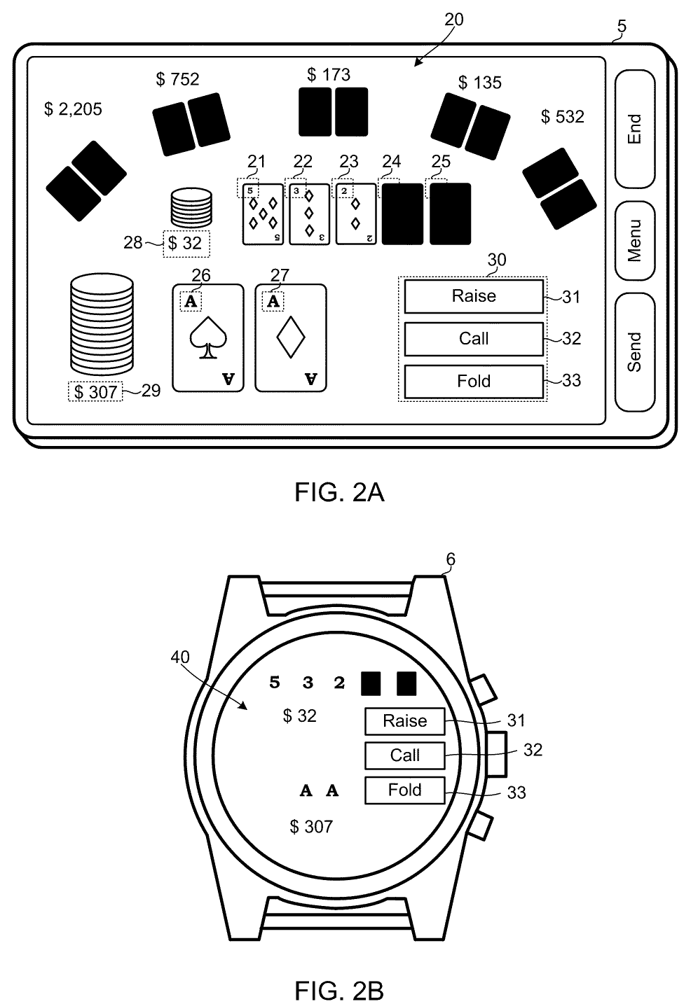

By way of illustration, a mobile device 5 and an electronic wristwatch 6 configured with windowed GUI environments are shown in FIGS. 2A and 2B to illustrate how a graphical application may be shared among multiple displays. In the illustrated example, a mobile device 5 is shown executing a poker application within a windowed GUI 20 in FIG. 2A. This illustrative poker application includes an interface display showing the status of the game along with virtual keys 31, 32, 33 for receiving touchscreen inputs from a user for controlling game play.

The windowed GUI 20 of the mobile device 5 may enable two or more applications to share the same display. Typically, windowed GUI systems enable toggling between one application display and another. For example, when the user receives an incoming voice call, the window manager may hide the poker game in order to display the graphical interface for the phone call application. However, toggling between application displays may not be ideal in some situations or applications. The mobile device 5 may provide other methods for sharing the display among multiple applications at the same time, such as alpha blending one application's output onto anther or displaying application interfaces within the traditional movable and resizable windows familiar to users of desktop operating systems. However, sharing a display is not ideal for some applications. For example, if the user is watching a video on the mobile device 5 while playing the poker game shown in FIG. 2A, the user may wish to view the video on the entire display without having to toggle between the movie and the game, and without obscuring a portion of the video to reveal the game information. The various aspects overcome these disadvantages by enabling an application executing on one computing device to display on another computing device.

FIG. 2B shows an electronic wristwatch display 6 having a GUI window 40 to which portions of the poker game display have been ported from the mobile device 5. The various aspects enable a user to select the portions of the poker application that are most relevant to the user, such as the portions displaying his cards and money, and to present those selected portions on the electronic wristwatch display 6.

To generate the display image according to an aspect, a user may designate portions of the windowed GUI 20 on the mobile device 5 that should be mashed up and ported it to the electronic wristwatch display 6. This is illustrated in FIG. 2A, which shows user selection bounding boxes 21-30 highlighting those portions of the windowed GUI 20 that should appear in the windowed GUI 40 of the wristwatch display 6. For example, the selection bounding boxes 21-25 select those portions of the poker application that shows the values of the cards on the table. Thus to present a display on the electronic wristwatch 6 that shows the status and values of those cards, the user need only select the portions of the display in bounding boxes 21-25, obviating the need for the poker application values to be interpreted in transformed into a second form of display. Further, the user is able to select the information to be displayed, as the example shows that the user has elected to not include the suit of the cards in the ported display.

In an alternative aspect, the application itself may determine the portions of the main display that should be ported to the slave device. In this aspect, the application may be informed of the display capabilities of the slave device and use this information to define a display image that optimally fits that display. For example, if the application is informed that the slave device has a 176×144 display, it may render an image suitable for this sized display. This may include rendering objects differently based upon the pixel and color resolution of the display, such as using simple icons for low resolution displays and using complex icons for high resolution displays. The automatic resizing of display images may also include generating a more extensive and larger display image when the slave device has a larger, more capable display than the master device. For example, if the application is running on a cellular telephone master device with a 640×480 display and the image is being ported to a 1080 P high definition television, the application may render a larger more detailed display image suitable for the television format.

FIGS. 2A and 2B also illustrate how virtual keys appearing on the display of a first device can be ported to the display of a second device. In the illustrated example, the user has designated a selection bounding box 30 encompassing the virtual keys 31, 32, 33 for controlling the poker game play. As result, the virtual keys 31, 32, 33 appear on the windowed GUI 40 of the electronic response displays 6. As explained more fully below, the methods for reporting the images of the virtual keys to the second device enables translating activation of those virtual keys on the second device into the appropriate commands for the application running on the first device. Thus, if a user presses the “Raise” image on the wrist watch with windowed GUI 40, this event can be communicated to the mobile device 5 so that it can be interpreted as a press of the “Raise” virtual key 31 as if it had occurred on the mobile device itself.

FIGS. 2A and 2B illustrate some advantages of various aspects. For example, the mobile device 5 as the processing power and network access capabilities to present a poker application, including enabling online game play. However, its size may not be convenient for use in all situations, and the display may need to be minimized during some uses of the mobile device, such as while conducting a telephone call. On the other hand, the electronic wristwatch display 6 is very convenient in that it fits on the wrist and so can be viewed at times when the mobile device 5 display cannot. However, the memory and processing power of the electronic wristwatch 6 is necessarily limited by its small size. Thus the aspects enable users to enjoy the use of an application on a convenient computing device, such as electronic wristwatch display, that may not have sufficient computing power to run the application. Further, enabling the user to designate those portions of the display to be presented on the second meeting device enables users to easily customize an application to their preferences. Thus, the various aspects may enable users to take advantage of the best aspects of two computing devices.

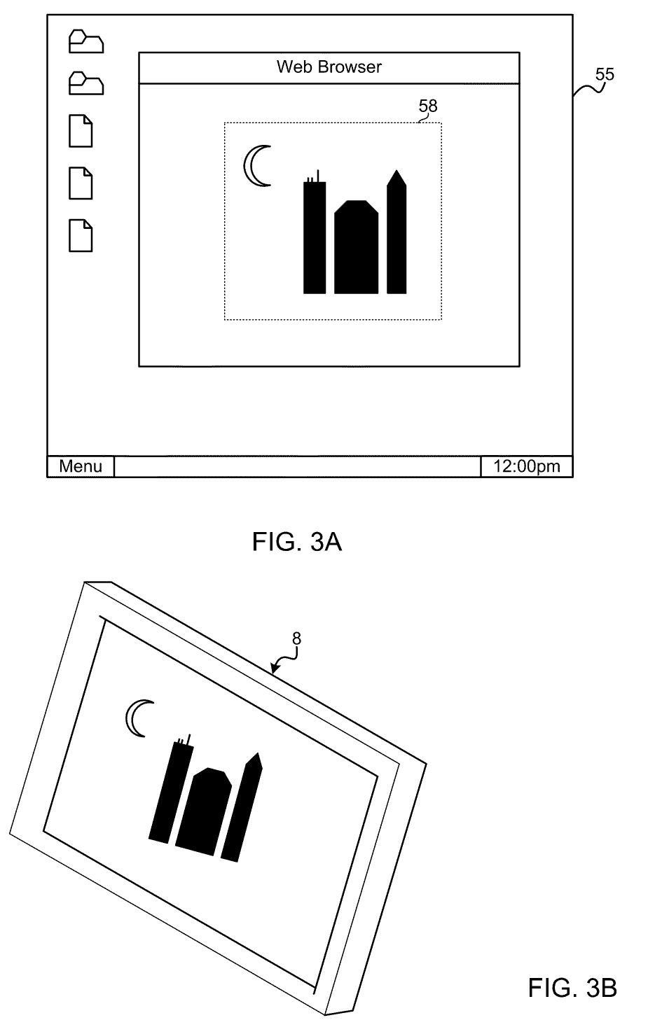

The various aspects may be used in a variety of other ways that may have user benefits. For example, FIGS. 3A and 3B illustrate an implementation in which a portion of desktop display including an image is selected and ported for display on a digital picture frame 8. FIG. 3A shows a desktop display 55 of a computer workstation on which is presented a web browser displaying a web cam image. If a user wishes to present the web cam image on another display device, such as a digital picture frame 8, the user can implement an aspect of the present invention to select a portion 58 of the desktop display 55 to be transmitted to the digital picture frame 8. As shown in FIG. 3B, the various aspects may enable the user present only the desired portion of the web browser display on a peripheral computing device such as the digital picture frame 8.

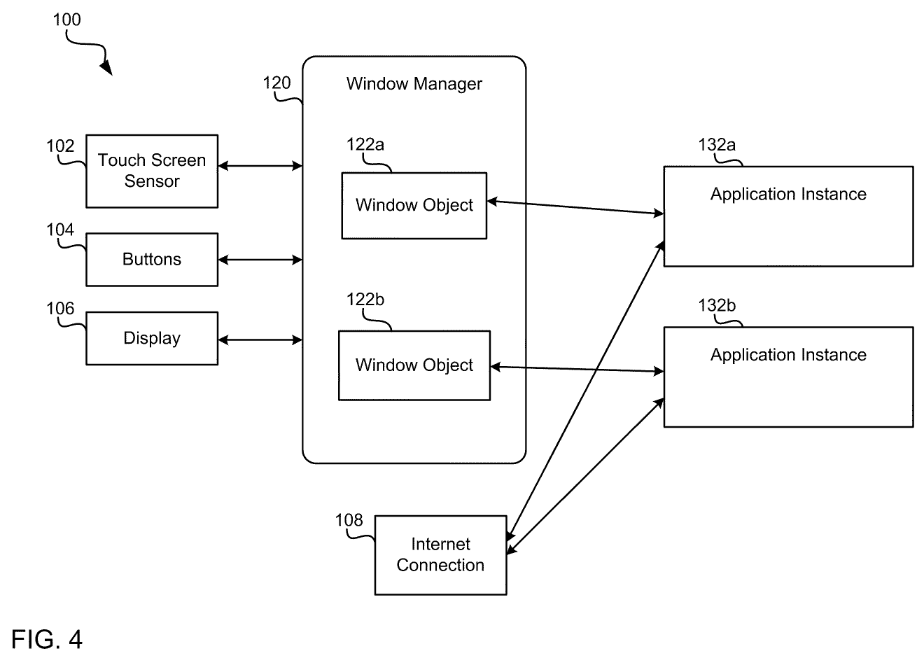

Computing devices capable of running a windowed GUI may utilize a window manager to coordinate sharing of input and output devices among user-space applications. An example of how a window manager 120 may interact with other aspects of a computer operating system 100 is illustrated in FIG. 4, which shows software components that may be implemented on a computing device. Computing device typically utilize an operating system 100 to manage various input and output devices, such as a touch screen sensor 102, a plurality of buttons 104, and a display 106. The various input devices on a computing device may include both hardware components for converting user inputs to electrical signals, and software components, such as a device driver, which allow the operating system 100 to provide the electrical signals to the applications in a suitable manner.

The various output devices of a computing device may also include hardware components that physically change based on received electrical signals, and corresponding software components, such as a device driver, which create the electrical signals based commands received from other parts of the operating system 100. In the case of a display 106, its device driver may include a system frame buffer.

The operating system 100 may allocate some of the input and output resources exclusively to a window manager 120. The operating system 100 may also have additional input and output devices corresponding to hardware and software components that are not allocated to the window manager 120, such as an Internet connection 108 corresponding to a network interface. Some applications may not require direct user interaction and will only utilize hardware resources not managed by the window manager 120. An application that operates independently of user input may be referred to as a daemon (or daemon application) or a terminate and stay resident (“TSR”) application.

The operating system 100 may also include a plurality of application instances 132a, 132b that may require use of the display 106. The application instances 132a, 132b may also require user input periodically, such as from the buttons 104 and/or the touch screen sensor 102. For each such application instance 132a, 132b, the window manager may maintain state information in the form of a window object 122a, 122b. Such state information may include the size and shape of the window corresponding to the application instance 132a, 132b and an identifier that the window manager 120 may use to communicate with the application instance 132a, 132b. In an aspect in which the window manager 120 is similar to a “compositing” window manager, the window object 122a, 122b may include a buffer storing the graphical output of the application instance 132a, 132b. Some computing devices with smaller displays may not provide the user with movable and resizable windows corresponding to applications. A window manager 120 on such a device may simply allow the user to “toggle” between application displays.

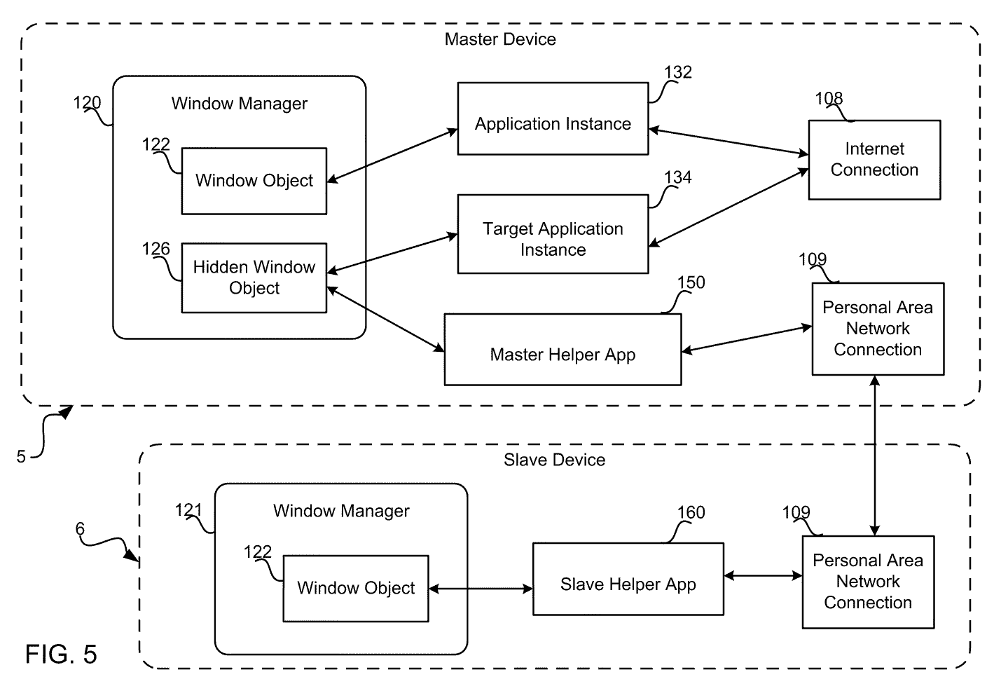

The various aspects may utilize a window manager 120 to display an application executing on a master computing device and displaying on a slave computing device (i.e., the target application). An overview example of how a window manager 120 may interact with various applications to accomplish such a method of display is illustrated in FIG. 5, which shows software components that may be implemented on master and slave computing devices. The master device 5 may be the computing device (e.g., a mobile device) hosting the target application instance 134. The target application instance 134 execute in the processor and memory of the master device 5 and directly uses the resources of the master device 5, such as the Internet connection 108. The master device 5 may also host another application instance 132. The master device 5 may utilize a window manager 120 to manage the input and output of the various application instances 132 and 134. As previously discussed, the window manager 120 may utilize a window object 122 to store state information relating to the various application instances 132 and 134.

As described above, the various aspects may utilize helper apps 150, 160 to coordinate the sharing and communication of display buffers from the master and slave devices. As illustrated in FIG. 5 the master helper app 150 may be implemented on the master device 50 to assist in preparing display images and buffers for communication to the slave device 6, and the slave helper app 160 may be implemented on the slave device 6 to assist in receiving the display buffers and rendering the associated images.

The state information relating to the target application instance 134 may be referred to as a hidden window object 126 while the target application instance 134 is displaying on a slave device 6. In some aspects, the user may have the option of removing the target application instance 134 from the desktop while it is displaying on the slave device 6. In such an aspect, the hidden window object 126 will not be accessed by the aspect of the window manager 120 that aggregates the various windows onto the system frame buffer. The hidden window object 126 may include a buffer to store the output of the target application 134. The buffer may be of sufficient size to store the entire output of the target application 134. Alternatively, the buffer may be of a size equal to the user-selected portions of the target application 134 that are to be displayed on the slave device 6. The master helper app 150 may access the buffer of the hidden window object 126 and send the display portion to the slave device 6 via a personal area network 109, such as a Bluetooth® connection. In some aspects, the user will have the option to display the target application instance 134 on both the master device 5 and the slave device 6 simultaneously. Such an aspect may not utilize a buffer within the hidden window object 126. In such case, the master helper app 150 may access the system frame buffer to collect the portion to be displayed on the slave device 6.

In the various aspects, the slave device 6 may implement a window manager 121. The slave device 6 may also include a slave helper app 160 for receiving the display portions from the master device 5 via a personal area network connection 109. In some aspects, the window manager 121 of the slave device 6 may display the received portions by creating a window object 122 corresponding to the slave helper app 160, and displaying the window as it would a typical window. In some aspects, the user may have the option of having the target application instance 134 “take over” the display of the slave device 6 (i.e., full screen mode). Alternatively, the user may have the option of displaying the target application instance 134 as a normal movable window on the slave device 6.

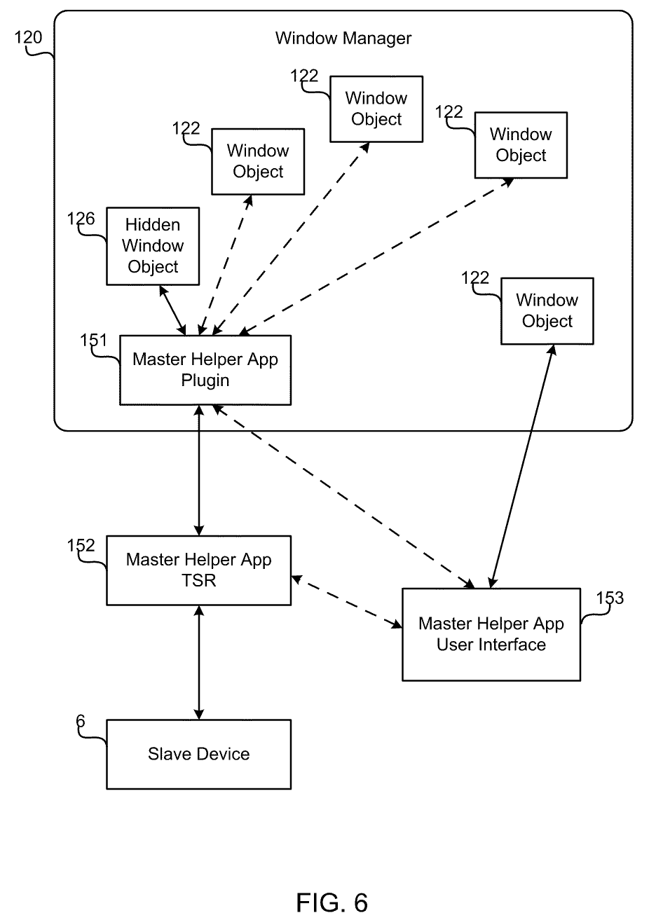

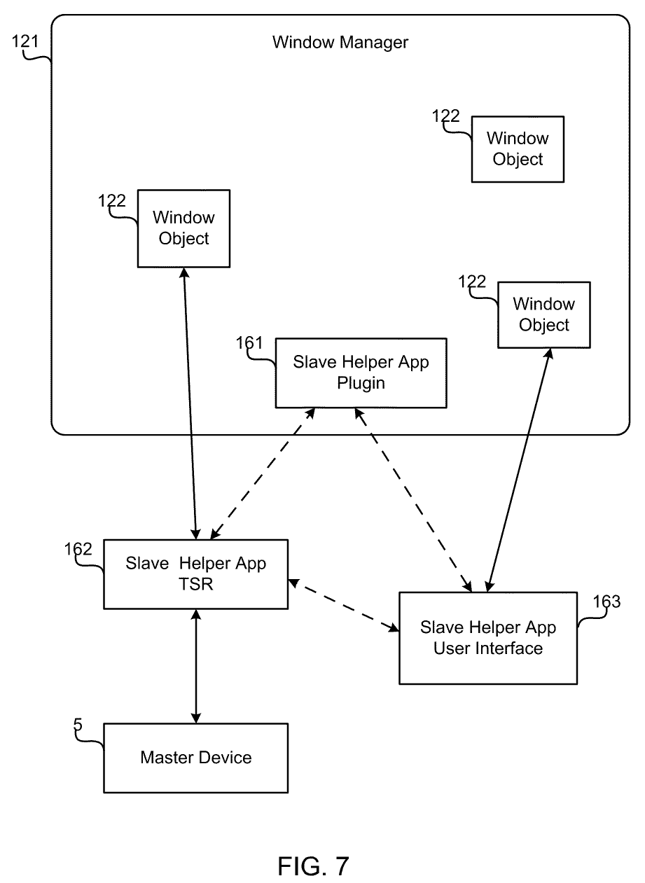

As discussed above with reference to FIG. 5, the various aspects may utilize helper apps to communicate display buffers across the master and slave devices. In some aspects, the master and slave helper apps may include sub-components running on the master and slave devices. Examples of some sub-components that may be implemented to provide the functions of the helper apps are illustrated in FIGS. 6 and 7, which show software components that may be implemented on master and slave computing devices, respectively.

Referring to FIG. 6, the window manager 120 of a master device 5 may include a master helper app plug-in sub-component 151. The master helper app plug-in 151 may provide an interface to retrieve data from a hidden window object 126, corresponding to the target application instance 134. The master helper app plug-in 151 may also provide an interface for the window manager 120 to receive information regarding the slave device 6, including input events such as a mouse over event. In some aspects, the slave device 6 may provide windowing data such as the size of the display window on the slave device 6 and whether it is dirty or occluded. Such information may be relayed to the application instance 134 by the master helper app 150 via the master helper app plug-in 151.

The master helper app 150 may also include a master helper app TSR sub-component 152 (i.e., a “terminate and stay resident” application). The master helper app TSR 152 may communicate with other devices to discover any potential slave devices 6. It may also transfer the display buffer of the target application instance 134 to the slave devices 6 by querying the window manager 120 via the master helper app plug-in 151. In some aspects, the master helper app TSR 152 may transform the output of the target application instance 134 based on user preferences and the capabilities of the slave device 6. For example, the target application instance 134 may be designed to run on a mobile device that does not provide movable and resizable windows. Accordingly, the target application instance 134 may not have the inherent capability to resize its output to suit a smaller display, such as that of a watch. In such an instance, the hidden window 126 may include a display buffer equivalent to the screen size of the mobile device and the master helper app TSR 152 may crop, resize, and rotate the buffer before passing it to the slave device 6.

The master helper app 150 may also include a master helper app user interface 153. The master helper app user interface 153 may provide the user with the ability to define portions of an application to send to a slave device 6 and to define some of the specifics for display, such as the slave device to use, whether or not to take over the slave display, and the refresh rate between the master and slave device. The master helper app user interface 153 may be a graphical application with a corresponding window object 122 within the window manager 120. In order to provide the user with the proper options, the master helper app user interface 153 may gather data about the identity and capabilities of the slave devices 6 from the master helper app TSR 152. The master helper app user interface 153 may also gather information from the window manager 120 via the master helper app plug-in 151 that may be used to provide the user with the ability to define the application portions.

Referring to FIG. 7, the slave helper app 160 may also be comprised by various sub-components. The slave helper app TSR 162 may receive a display buffer from the master device 5 and paint it to a corresponding window object 122. It may also send data to the master device 5 received from the window manager 120 corresponding to user input events or other window events such as an occlusion. Further, it may query the window manager 120 for its display capabilities via a slave helper app plug-in 161. The slave helper app TSR 162 may also communicate with master devices to discover each other. The slave helper app 160 may further include a slave helper app user interface 163 for providing the user with the ability to define preferences. In some aspects the slave helper app user interface 163 will provide the user with the ability to accept or reject certain connections to prevent an unwanted or hostile application from taking over the display.

The various components shown in FIGS. 6 and 7 may be categorized as slave or master for a specific function. A particular computing device may be a slave in some instances or a master in others, while having only one helper app plug-in, one helper app TSR and one helper app user interface. In some aspects, the capabilities for slave and master may be separated across applications. Alternatively, a computing device capable of being both a slave and a master may have a single plug-in and a single interface, but separate TSRs.

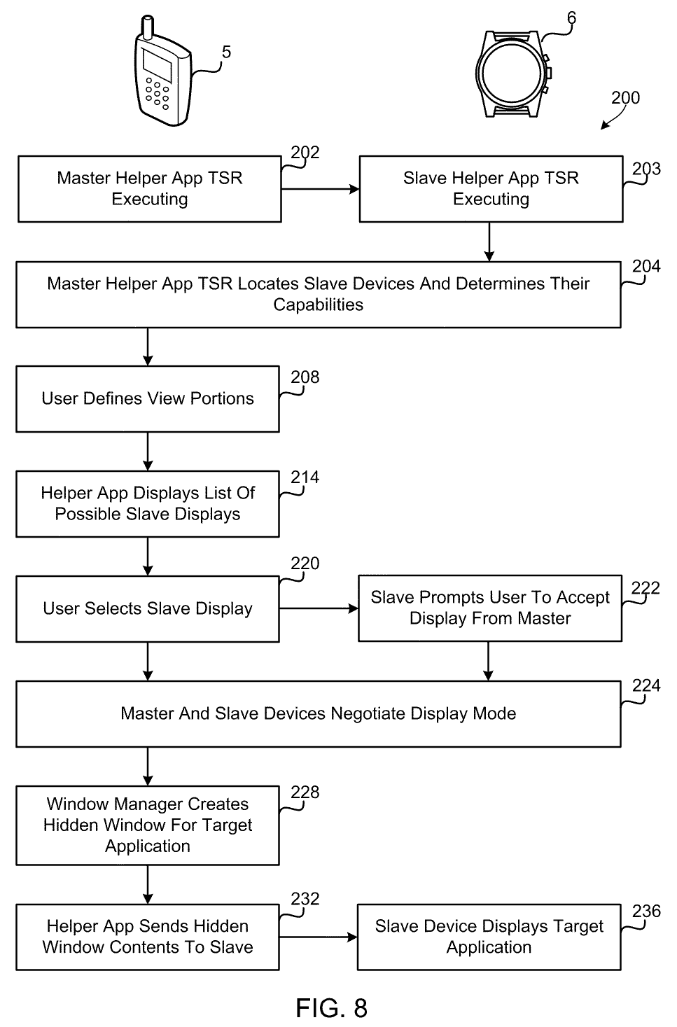

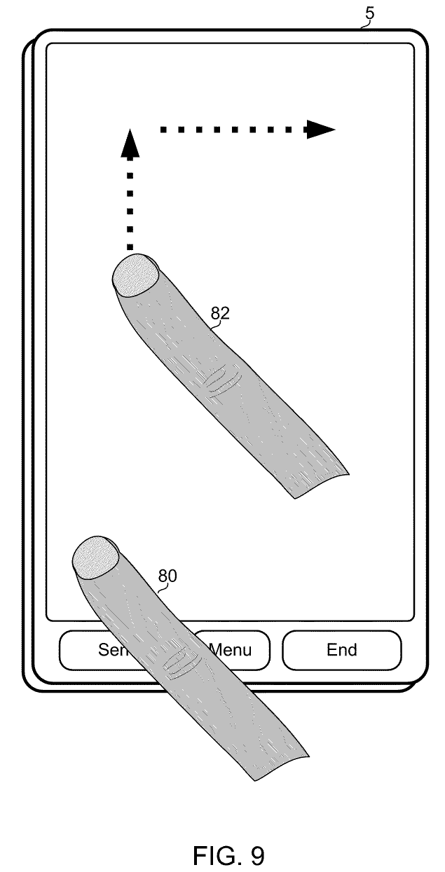

An aspect method for establishing a display across multiple computing devices is illustrated in FIG. 8, which shows process 200 that may be implemented in a computing device. In process 200 at blocks 202 and 203, a master device 5 may begin executing a master helper app TSR 152, and a slave device 6 may begin executing a slave helper app TSR 162 at block 203. At block 204 the master helper app TSR 152 may locate potential slave devices by sending a broadcast message across a network, such as a Bluetooth® device discovery frequencies, and receiving a response including the slave devices display capabilities. At block 208 the master device may receive user inputs defining the portions of the application interface that are to be displayed on a slave device at block 208. For example, the user may initiate the process by entering a keyboard sequence (e.g., ctrl+f13), by selecting a menu option on the window menu (i.e., the menu containing window control options such as minimize and exit), or by entering a specific gesture on a touch screen device. The user may then define certain rectangular marquees within the target application instance 134 that are to be displayed on the slave device. In some aspects, the process of initiating and defining may happen simultaneously, as discussed below with reference to FIG. 9.

At block 214 of process 200, the master helper app user interface 214 may provide the user with a list of slave devices that are available (i.e., in communication with the master device). At block 220 the master helper app may receive the user's selection of a slave device and inform the slave helper app of the selection. At block 222 the slave helper app may cause the slave device 6 to generate a display prompting the user to confirm acceptance of porting of display images from the master device 5. For example, the generated prompt may inform the user that a computing device has contacted it over a Bluetooth®v connection and would like to establish a link that will take over the device's display. The slave helper app may be configured to interpret a particular button press as indicating user confirmation of the connection. The slave helper app may determine if a user input indicates confirmation of acceptance of transmission of the display image and, if so, notify the master device that it will accept image data transmissions and/or accept the image data transmissions. This confirmation process is optional and may be provided to protect against inadvertent or unauthorized porting of images to a computing device.

In some aspects, there may be only a single possible slave display and blocks 214 and 220 may be performed automatically. Once the slave device has been selected and (optionally) the user has accepted the image porting to the slave device, at block 224 the master and slave devices may negotiate the particular display mode. This negotiation process may include setting the proportions of the display area available on the slave device, setting the refresh rate between the devices, and determining whether and which window events will be relayed from the slave device to the master device. This negotiation may involve contemporaneous user interaction on either or both of the master and slave devices, such as selecting among various display options, and also may involve determining preexisting user preferences on either the slave device or the master device.

In process 200 at block 228 the window manager 120 of the master device 5 may establish a hidden window 126 for the target application instance 134. In some aspects, the target application instance 134 may already be painting to a window object 122. The window manager 120 may convert the window object 122 to a hidden window object 126 by a series of processes that involve creating an additional display buffer. In an aspect where the window manager 120 is “compositing,” there may already have been a display buffer associated with the window object 122. At block 232 the master helper app TSR 152 accesses the display buffer of the hidden window object 126 and forwards them to the slave device 6, where it is displayed by the slave device at block 236. The various processes involved in establishing a multi-device display may occur in a variety of sequences. In some aspects, the helper application may not look for slave devices until the user has defined the display portions at block 214.

The process 200 may also be used to display on the slave device portions of display images from multiple applications generated on the master device. In such implementations, the master device may have two or more applications running (or multiple webpage instances) displayed and at block 208 may receive user inputs defining portions of the display images from the multiple applications. At block 228 the window manager 120 of the master device 5 may establish a hidden window 126 for the multiple applications.

In an alternative aspect, the selection of image portions to be ported to the slave device at block 208 may be performed automatically by the application generating the image instead of by the user. In this aspect the application generating the image may be configured to receive characteristics about a computing device display, including the characteristics of a slave device display, and determine an appropriate display layout and content based on those characteristics. Thus in this aspect, at block 208 the master helper app may supply to the application running on the master device the slave device capabilities, which the application uses to define portions of the display to be ported to the slave device. The application may identify the defined image portions to the master helper app so that it may accomplish the other operations described herein.

The various aspects may enable users to define the desired application portions using a mouse or other pointing device to select rectangular marquees. FIG. 9 shows an aspect user interface gesture suitable for use on computing devices configured with a touch screen user interface. In this aspect the user can define a desired application portion by placing one finger 80 on a predefined location on the touch screen, such as the lower left corner, and using two motions with a second finger 82 to define a rectangular marquee, one horizontal motion to define the left most and right most coordinates and vertical motion to define the top most and bottom most coordinates.

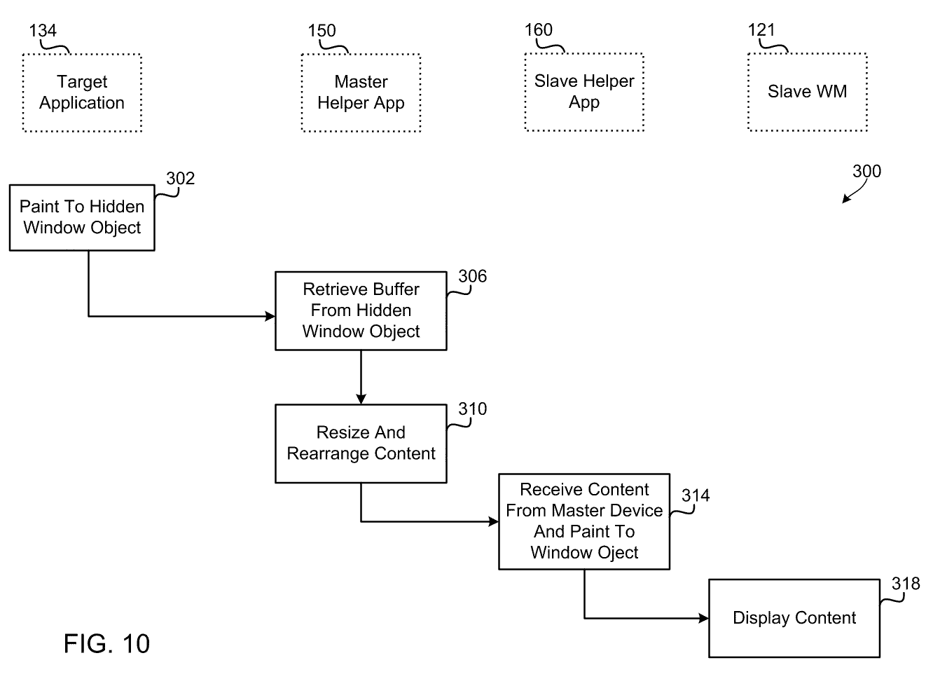

The aspects described above with reference to FIGS. 5-8 involve implementations in which the master device 5 creates the display portions and forwards those portions to the slave device 6 for processing. A process 300 for accomplishing such a display transfer from a master device to a slave device is shown in FIG. 10. In process 300 at block 302 the target application instance 134 may paint to a hidden window object 126. At block 306 the master helper app 150 may retrieve the contents of the buffer at block 306, transform the buffer contents so they are suitable for display on the slave device, and provide the results to the slave device at block 310. In transforming the buffer contents, the helper app 150 may resize the image contents to fit the display size and characteristics of the slave device 6. In an alternative aspect, the helper app 150 may communicate with the application so that at block 302 the application paints an image to the hidden window object 126 in a size and format suitable for the slave device, so that at block 310 the master helper app 150 need only present the contents of the buffer to the slave device. As noted above, transforming the buffer contents or directing the application to paint an image to the hidden window object suitable for the slave device may generate a display image that is smaller and less extensive than an image suitable for the master device, or a display image that is larger and more extensive than an image suitable for the master device.

At block 314 slave helper app 160 may receive a display buffer from the master device, and the window manager 121 of the slave device 6 may display the contents at block 318. The slave window manager 121 may display the portions of the target application instance 134 in full screen mode, where the portions utilize the entire slave device display (i.e., the master device takes over the slave display). Similarly, the slave window manager 121 may display the portions in overlay mode, where the portions are alpha blended over the other graphical applications on the slave device. Further, the slave window manager may display the portions in “fit both” mode, where the portions are displayed alongside the graphical applications of the slave device. This may be accomplished by allocating the slave helper app 160 to a movable window object 120. Alternatively, this may be accomplished by allocating a fixed portion of the slave display to the slave helper app 160 and fitting the rest of the graphical applications into the remainder.

Some computing devices suitable for functioning as a slave device may not have the available computing power or otherwise be unable to handle the processing required for the overlay or fit both mode modes of display. In some aspects, the slave device may be capable of sending the output of its various graphical applications to the master device whereby the master device may perform the transformations.

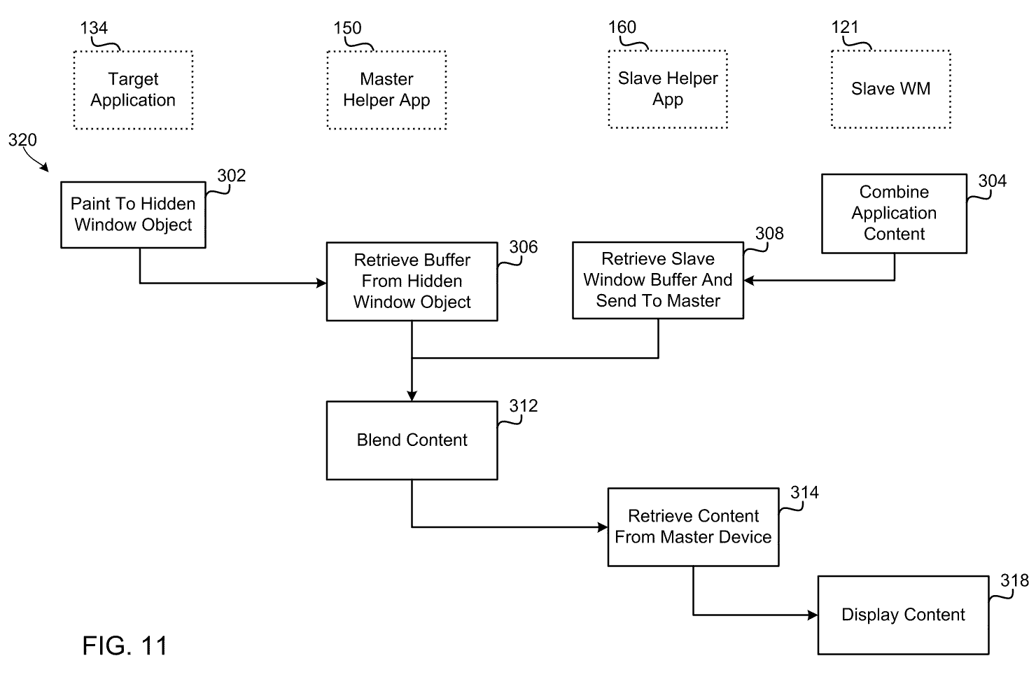

A method for accomplishing such a display is shown in FIG. 11, which shows process 320 that may be implemented on multiple computing devices. In process 320 at block 302, the target application instance 134 may paint to a hidden window 126, which may include a window buffer. As noted above, in an alternative aspect, the master helper app 150 may communicate with the application, so that at block 302 the application paints an image to the hidden window object 126 in a size and format suitable for the slave device. At block 306, the master helper app 150 may retrieve the contents of the buffer. At block 304, the slave window manager 121 may aggregate the contents of the graphical applications and store them in an aggregate buffer. This may be accomplished in a manner similar to how the slave window manager 121 would aggregate the applications and store them in the system frame buffer when not functioning as a slave device. At block 308, the slave helper app 160 may access the aggregate buffer and deliver its contents to the master device where it is received by the master helper app 150. At block 312 the master helper app 150 may transform the content of the window buffer, blend the contents with the slave aggregate buffer so that it is suitable for display on the slave device, and transmit the results to the slave device. At block 314, the slave helper app 160 may receive the blended contents from the master helper app 150, where the contents are displayed by the slave window manager 121 at block 318.

In addition to displaying application portions on a slave device, some aspects may enable the user to interact with the target application on the slave device. In a typical windowed GUI, graphical applications may establish certain code to be executed when an input event occurs. For example, in the previously discussed poker application, pressing the touch screen at a point within a box defined for the “fold” button may cause the poker application to send a data communication to the server indicating that the user folds. The various aspects may allow for an input event on a slave device to execute code on the master device. In the example of the poker application, the user may touch the screen of the slave device and cause the poker application running on the master device to send a message from the master device to the server indicating that the user folds.

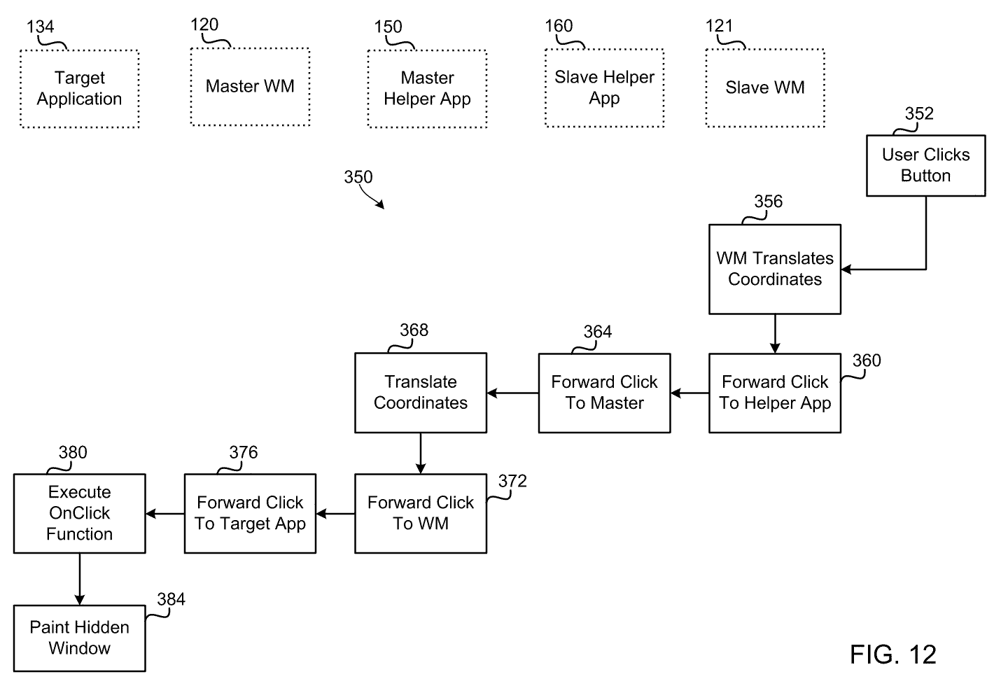

An example method providing for such an interaction is illustrated in FIG. 12, which shows process 350 that may be implemented on multiple computing devices. In process 350 at block 352 the slave device may receive a user input in the form of a press of a button on the slave device 6. On slave devices that include a touchscreen display, the user input may be in the form of a touch event that includes the coordinates of the user's touch. At block 356 the slave window manager 121 may receive the input signal and determine from its state information relating to window objects 122 that the input signal belongs to the window managed by the slave helper app 160 (i.e., the application portions). At block 360 the slave window manager 121 may generate a message to send to the slave helper app 160 indicating the type of input event (i.e., a button click) and the particular button depressed or the relative coordinates of the touchscreen touch event. At block 364 the slave helper app 160 may receive the input event from the slave window manager 121 and forward the input event to the master device 5, where it is received by the master helper app 150. At block 368 the master helper app 150 may receive the input event and determine how the received coordinates correspond to the target application 134 based on the stored information mapping the pixels in the buffer of the hidden window 126 to the user-defined application portions. At block 372 the master helper app 150 may send a message to the master window manager 120 including the input event type and the translated coordinates. At block 376 the master window manager 120 may receive the message indicating an input event and, in response, send a message to the target application 134. At block 380 the target application 134 may receive the message and determine, based on the input event type and the translated coordinates, that the user has clicked a button with a corresponding function (i.e., an “onclick” function), and then execute that function. At block 384 the target application may also paint to the hidden window (i.e., provide pixel output) based on the execution of the function.

The various processes involved in displaying application portions on a slave device may be resource intensive. As discussed above with reference to FIG. 11, the various aspects may determine how to allocate the processing burden based on relative computing capabilities. Some aspects may enable a proxy device to render the application portions and/or combine the application portions with the output of the slave device. For example, a user may wish to display a video on a goggle-like computing device where the video is actually playing on a mobile device (i.e., the video player is accessing the video file on the storage of the mobile device and decoding the video using the CPU of the mobile device). The mobile device may or may not be capable of decoding the video and managing the display of the goggles at the same time, but the user may wish to offload the rendering of the application portions to a nearby device to save battery power or to reserve processing power for other applications on the mobile device. This may be accomplished with an aspect of the present invention in which some of the processing is performed by a proxy device in communication with the master and slave devices.

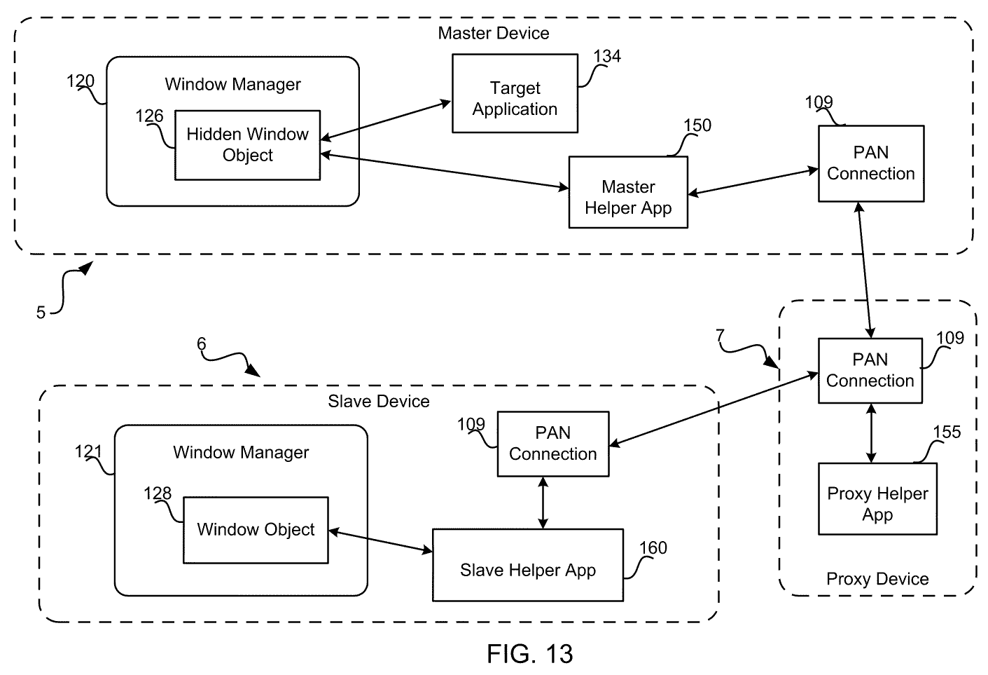

An example of the various software components that may be implemented in computing devices in such a configuration is shown in FIG. 13. As described above, the master device 5 may implement a master window manager 120 with a hidden window object 126 corresponding to a target application instance 134. The master device 5 may also implement a master helper app 150 for communicating with slave devices 6 and proxy devices 7 (e.g., a nearby laptop computer) via a personal area network connection 109. There may be a slave device 6 that includes a slave window manager 121 with a window object 122 corresponding to a slave helper app 160. The slave helper app 160 may communicate with master devices 5 and proxy devices 7 via a personal area network connection 109, such as a Bluetooth® network. There may further be a proxy device 7 that includes a proxy helper app 155 for communicating with master devices 52 and slave devices 6 via a personal area network connection 109.

An example method for displaying a multi device display is illustrated in FIG. 14, which shows process 390 that may be implemented on multiple computing devices. In process 390 at block 302, target application instance 134 may paint to a hidden window 126, which may include a window buffer. At block 306, the master helper app 150 may retrieve the contents of the buffer and deliver its contents to the proxy helper app 155. As noted above, in an alternative aspect, the master helper app 150 may communicate with the application so that at block 302 the application paints an image to the hidden window object 126 in a size and format suitable for the slave device. This may include directing the application to paint an image that can be easily aggregated with content from the slave device. Using information provided by the master helper app, an application may paint an image that is larger or smaller than what is suitable for display on the master device. At block 304, the slave window manager 121 may aggregate the contents of the graphical applications and store them in an aggregate buffer. At block 308 the slave helper app 160 may access the aggregate buffer and deliver its contents to the proxy helper app 155. At block 312, the proxy helper app 155 may perform processes of mapping the contents of the hidden window 126 buffer to the display portions and fitting the display portions within the output of the other applications on the slave device 6. At block 314, the slave helper app 160 may receive a display buffer from the master device, and the window manager 121 of the slave device 6 may display the contents at block 318.

In a further application of the various aspects, a slave device 6 may be configured to relay display images on to a second slave device. FIG. 15 shows a software component diagram of three computing devices 5, 6a, 6b that may enable such image sharing. As described above, the master device 5 may implement a master window manager 120 with a hidden window object 126 corresponding to a target application instance 134. The master device 5 may also implement a master helper app 150 for communicating with slave devices 6a, 6b via a personal area network connection 109. There may be a first slave device 6a that includes a slave window manager 121a with a window object 122a corresponding to a slave helper app 160a. The slave helper app 160a may communicate with master devices 5 and other slave devices 6b via a personal area network connection 109a, such as a Bluetooth® network. Additionally, the first slave device 6a may include a master helper app 150a for communicating with other slave devices 6b via a personal area network connection 109. Similarly, a second slave device 6b may include a proxy helper app 155 for communicating with master devices 5 and other slave devices 6a via a personal area network connection 109.

When slave devices 6a include both a master helper app 150a and a slave helper app 160a they can function as either a master or a slave device, or both so that they can relay a slave display on to a second slave device. Processes for relaying a display image on to a second slave device 6b are consistent with those described above with reference to FIGS. 8, 10-12 and 14, with the relaying slave device 6a implementing both slave and master device processes. Using such an aspect, a user may port a display image to his/her electronic wristwatch display, and then port that display on to a friends electronic wrist watch display so they can share the experience.

Processes 300, 320, 350 and 390 may also be used to port display portions from multiple target applications or webpages operating on the master device to a slave device. To accomplish this, at block 302, each of the target applications or webpages may be directed to paint their display output to the hidden window object 126. Thereafter each of processes 300, 320, 350 and 390 proceed in a similar fashion as in the case of a single application display.

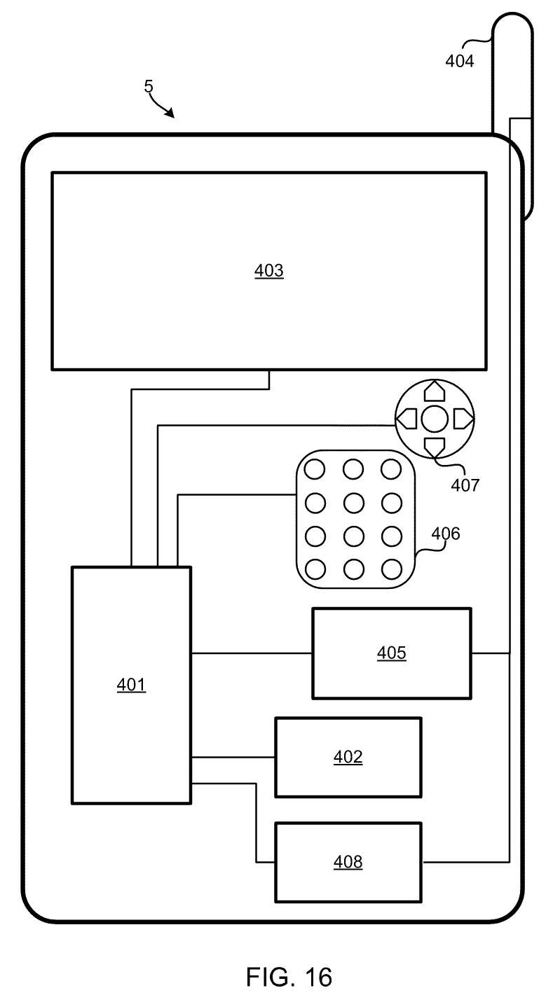

The aspects described above may be implemented on any of a variety of portable computing devices, such as, cellular telephones, personal data assistants (PDA), mobile web access devices, and other processor-equipped devices that may be developed in the future configured to communicate with external networks, such as via a wireless data link. Typically, such portable computing devices will have in common the components illustrated in FIG. 16. For example, the portable computing devices 5 may include a processor 401 coupled to internal memory 402 and to a display 403. Additionally, the portable computing device 5 may have an antenna 404 for sending and receiving electromagnetic radiation, that is connected to a wireless data link and/or cellular telephone transceiver 405 coupled to the processor 401. Portable computing devices 5 also typically include a key pad 406 or miniature keyboard, and menu selection buttons or rocker switches 407 for receiving user inputs, as well as a speaker 409 for generating an audio output.

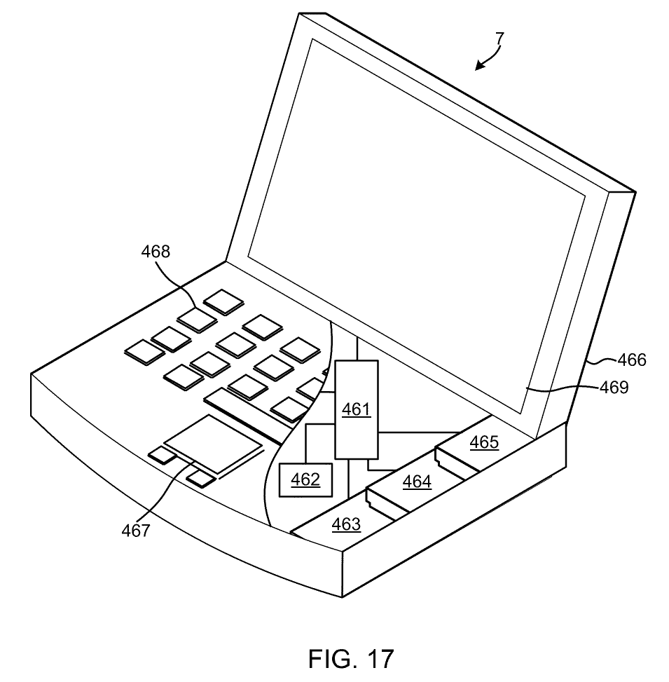

A number of the aspects described above may also be implemented with any of a variety of computing devices, such as a notebook computer 7 illustrated in FIG. 17. Such a notebook computer 7 typically includes a housing 466 that contains a processor 461 coupled to volatile memory 462, and a large capacity nonvolatile memory, such as a disk drive 463. The computer 7 may also include a floppy disc drive 464 and a compact disc (CD) drive 465 coupled to the processor 461. The computer housing 466 typically also includes a touchpad 467, keyboard 468, and the display 469.

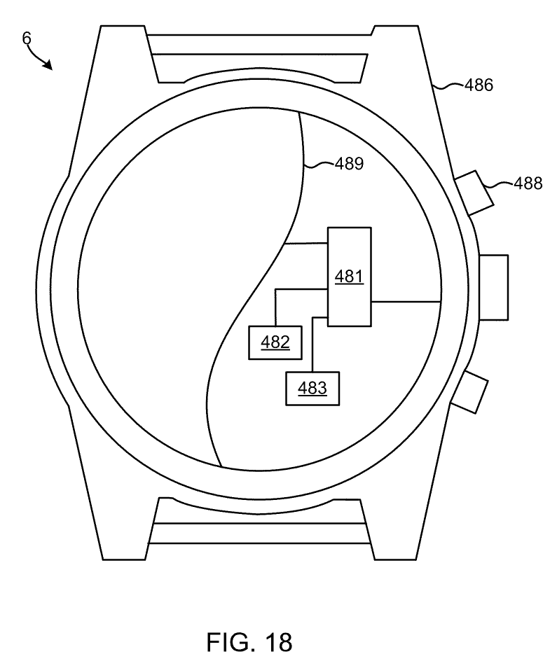

A number of the aspects described above may also be implemented with any of a variety of computing devices, such as a wrist computer 6 illustrated in FIG. 18. Such a wrist computer 6 typically includes a housing 486 that contains a processor 481 coupled to volatile memory 482, and a large capacity nonvolatile memory, such as a solid state drive 483. The computer housing 486 typically also includes plurality of buttons 488 and a touch-screen display 489.

The processor 401, 461, 481 may be any programmable microprocessor, microcomputer or multiple processor chip or chips that can be configured by software instructions (applications) to perform a variety of functions, including the functions of the various aspects described above. In some computing devices, multiple processors 401, 461, 481 may be provided, such as one processor dedicated to managing data communications, and one processor dedicated to running other applications.

The various aspects may be implemented by a computer processor 401, 461, 481 executing software instructions configured to implement one or more of the described methods or processes. Such software instructions may be stored in memory 402, 462, 482, in hard disc memory 464, on tangible storage medium or on servers accessible via a network (not shown) as separate applications, or as compiled software implementing an aspect method or process. Further, the software instructions may be stored on any form of tangible processor-readable memory, including: a random access memory 402, 462, 482, hard disc memory 463, a floppy disk (readable in a floppy disc drive 464), a compact disc (readable in a CD drive 465), electrically erasable/programmable read only memory (EEPROM) 483, read only memory (such as FLASH memory), and/or a memory module (not shown) plugged into the computing device 5, 6, 7 such as an external memory chip or a USB-connectable external memory (e.g., a “flash drive”) plugged into a USB network port.

The foregoing method descriptions and the process flow diagrams are provided merely as illustrative examples and are not intended to require or imply that the processes of the various aspects must be performed in the order presented. As will be appreciated by one of skill in the art, the order of blocks and processes in the foregoing aspects may be performed in any order. Words such as “thereafter,” “then,” “next,” etc. are not intended to limit the order of the processes; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm processes described in connection with the aspects disclosed herein may be implemented as electronic hardware, computer software, or combinations of both. To clearly illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some processes or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The processes of a method or algorithm disclosed herein may be embodied in a processor-executable software module executed, which may reside on a computer-readable medium. Computer-readable media includes both computer storage media and communication media, including any medium that facilitates transfer of a computer program from one place to another. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions stored on a machine readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method for displaying selected portions of a display image generated on a first computing device implementing a master helper application on a display of a second computing device implementing a slave helper application, comprising:
reformatting a display image generated by an application running on the first computing device to fit the display of the second computing device and storing the reformatted display image to a frame buffer of the first computing device as a hidden window object under direction of the master helper application;
transmitting the hidden window object display data to the second computing device via communication between the master helper application and the slave helper application;
storing the hidden window object display data in a frame buffer of the second computing device under direction of the slave helper application; and
rendering the display on the second computing device using the hidden window object display data stored in the frame buffer of the second computing device.

2. The method of claim 1, wherein reformatting a display image to fit the display of the second computing device and storing the reformatted display image to a frame buffer of the first computing device as a hidden window object under direction of the master helper application comprises:
directing an application running on the first computing device to paint a portion of the application's display image to the frame buffer of the first computing device as a hidden window object; and
reformatting the hidden window object display data to fit the display of the second computing device.

3. The method of claim 2, wherein:
reformatting the hidden window object display data to fit the display of the second computing device is accomplished in the first computing device under direction of the master helper application; and
transmitting the hidden window object display data to the second computing device comprises transmitting resized hidden window object display data to the second computing device.

4. The method of claim 2, wherein:
reformatting the hidden window object display data to fit the display of the second computing device is accomplished in the second computing device under direction of the slave helper application; and
transmitting the hidden window object display data to the second computing device comprises transmitting the original sized hidden window object display data to the second computing device.

5. The method of claim 2, further comprising transmitting the hidden window object display data to a third computing device, wherein:
reformatting the hidden window object display data to fit the display of the second computing device is accomplished in the third computing device; and
transmitting the hidden window object display data to the second computing device comprises transmitting resized hidden window object display data from the third computing device to the second computing device.

6. The method of claim 2, wherein reformatting the hidden window object display data to fit the display of the second computing device under direction of the master helper application comprises processing the hidden window object display data so the data will generate the display image compatible with the display of the second computing device.

7. The method of claim 2, further comprising receiving display data from the second computing device,
wherein reformatting the hidden window object display data to fit the display of the second computing device under direction of the master helper application comprises generating a blend of the hidden window object display data and the received second computing device display data to generate a single blended display image compatible with the display of the second computing device.

8. The method of claim 2, further comprising receiving display data from the second computing device,
wherein reformatting the hidden window object display data to fit the display of the second computing device under direction of the master helper application comprises generating a single display image compatible with the display of the second computing device that presents the hidden window object display data side-by-side with the received second computing device display data.

9. The method of claim 2, wherein transmitting the hidden window object display data to the second computing device comprises transmitting the hidden window object display data to the second computing device via a wireless data link established between the first and second computing devices.

10. The method of claim 9, wherein the wireless data link is a Bluetooth® wireless data link.

11. The method of claim 1, further comprising receiving a user input on the first computing device indicating a selection of the display image to be displayed on the second computing device,
wherein reformatting a display image to fit the display of the second computing device and storing the reformatted display image to a frame buffer of the first computing device as a hidden window object under direction of the master helper application comprises directing an application running on the first computing device to paint the indicated selected portion of the application's display image to the frame buffer of the first computing device as a hidden window object; and
reformatting the hidden window object display data to fit the display of the second computing device.

12. The method of claim 1, further comprising:
receiving a user input on the second computing device;
communicating information regarding the received user input to the master helper application on the first computing device;
correlating the communicating information regarding the received user input to the portion of the application's display image to determine a corresponding user input to the application operating on the first computing device; and
communicating the corresponding user input to the application operating on the first computing device.

13. The method of claim 1, further comprising:
notifying the second computing device that portions of a display image may be transmitted to it;
prompting a user of the second computing device to confirm agreement to receive the portion of the display image;
determining whether the user of the second computing device confirmed agreement to receive the portion of the display image; and
receiving the hidden window object display data in the second computing device if it is determined that the user of the second computing device confirmed agreement to receive the portion of the display image.

14. The method of claim 1, wherein reformatting a display image generated by an application running on the first computing device to fit the display of the second computing device and storing the reformatted display image to a frame buffer of the first computing device as a hidden window object under direction of the master helper application comprises:
providing characteristics of the display of the second computing device to the application running on the first computing device; and
receiving a display image from the application into the frame buffer in a format compatible with the display of the second computing device.

15. The method of claim 13, wherein the display image received from the application is sized for a display that is larger than a display of the first computing device.

16. The method of claim 1, further comprising:
transmitting the hidden window object display data from the second computing device to a third computing device;
storing the received hidden window object display data in a frame buffer of the third computing device; and
rendering a display on the third computing device using the hidden window object display data stored in the frame buffer of the third computing device.

17. A computing device, comprising:
a processor;
a memory coupled to the processor and configured to include a frame buffer; and
a transceiver coupled to the processor,
wherein the processor is configured with processor executable instructions to implement a master helper application that performs processes comprising:
reformatting a display image generated by an application running on the computing device to fit a display of a second computing device and storing the reformatted display image to the frame buffer in memory as a hidden window object; and
transmitting the hidden window object display data to the second computing device via the transceiver.

18. The computing device of claim 18, wherein the processor is configured with processor executable instructions such that reformatting a display image generated by an application running on the computing device to fit the display of a second computing device and storing the reformatted display image to the frame buffer in memory device as a hidden window object comprises:
directing an application running on the processor to paint a portion of the application's display image to the frame buffer as a hidden window object; and
reformatting the hidden window object display data to fit the display of the second computing device.

19. The computing device of claim 19, the processor is configured with processor executable instructions such that transmitting the hidden window object display data to the second computing device comprises transmitting resized hidden window object display data to the second computing device.

20. The computing device of claim 19, wherein the processor is configured with processor executable instructions such that transmitting the hidden window object display data to the second computing device comprises transmitting the original sized hidden window object display data to the second computing device.

21. The computing device of claim 19, wherein the processor is configured with processor executable instructions to implement a master helper application that performs processes further comprising receiving display data from the second computing device,
wherein reformatting the hidden window object display data to fit the display of the second computing device comprises generating a blend of the hidden window object display data and the received second computing device display data to generate a single blended display image compatible with the display of the second computing device.

22. The computing device of claim 19, wherein the processor is configured with processor executable instructions to implement a master helper application that performs processes further comprising receiving display data from the second computing device,
wherein reformatting the hidden window object display data to fit the display of the second computing device comprises generating a single display image compatible with the display of the second computing device that presents the hidden window object display data side-by-side with the received second computing device display data.

23. The computing device of claim 18, wherein:
the transceiver is a wireless transceiver; and
the processor is configured with processor executable instructions such that transmitting the hidden window object display data to the second computing device comprises transmitting the hidden window object display data to the second computing device via a wireless data link established between the transceiver and the second computing device.

24. The computing device of claim 23, wherein the transceiver is a Bluetooth® transceiver.

25. The computing device of claim 17, wherein the processor is configured with processor executable instructions to implement a master helper application that performs processes further comprising receiving a user input indicating a selection of the display image to be displayed on the second computing device,
wherein reformatting a display image to fit the display of the second computing device and storing the reformatted display image to the frame buffer as a hidden window object comprises:
directing an application running on the processor to paint the indicated selected portion of the display image to the frame buffer as a hidden window object; and
reformatting the hidden window object display data to fit the display of the second computing device.

26. The computing device of claim 17, wherein the processor is configured with processor executable instructions to implement a master helper application that performs processes further comprising:
receiving information regarding a user input from the second computing device;
correlating the information regarding the user input to the portion of the application's display image to determine a corresponding user input to the application operating on the processor; and
communicating the corresponding user input to the application operating on the processor.

27. The computing device of claim 17, further comprising notifying the second computing device that portions of the display image may be transmitted to it.

28. The computing device of claim 17, wherein the processor is configured with processor executable instructions such that reformatting a display image generated by an application running on the processor to fit the display of the second computing device and storing the reformatted display image to the frame buffer as a hidden window object comprises:
providing characteristics of the display of the second computing device to the application running on the processor; and
receiving a display image from the application into the frame buffer in a format compatible with the display of the second computing device.

29. The computing device of claim 28, wherein the processor is configured with processor executable instructions such that the display image received from the application is sized for a display that is larger than a display of the computing device.

30. A computing device, comprising:
a processor;
a memory coupled to the processor and configured to include a frame buffer;
a display coupled to the processor and to the frame buffer; and
a transceiver coupled to the processor,
wherein the processor is configured with processor executable instructions to implement a slave helper application that performs processes comprising:
receiving hidden window object display data from a second computing device;
storing the hidden window object display data in the frame buffer; and
rendering an image on the display using the hidden window object display data stored in the frame buffer.

31. The computing device of claim 30, wherein the processor is configured with processor executable instructions to implement a slave helper application that performs processes further comprising reformatting the hidden window object display data to fit the display.

32. The computing device of claim 31, wherein the processor is configured with processor executable instructions such that reformatting the hidden window object display data to fit the display comprises generating a blend of the hidden window object display data and display data from an application running on the processor to generate a single blended display image compatible with the display.

33. The computing device of claim 31, wherein the processor is configured with processor executable instructions such that reformatting the hidden window object display data to fit the display comprises generating a single display image compatible with the display that presents the hidden window object display data side-by-side with display data from an application running on the processor.

34. The computing device of claim 31, wherein:
the transceiver is a wireless transceiver; and
the processor is configured with processor executable instructions such that receiving the hidden window object display data from the second computing device comprises receiving the hidden window object display data via a wireless data link established between the transceiver and second computing device.

35. The computing device of claim 34, wherein the transceiver is a Bluetooth® transceiver.

36. The computing device of claim 31, wherein the processor is configured with processor executable instructions to implement a slave helper application that performs processes further comprising:
receiving a user input; and
communicating information regarding the received user input to the second computing device.

37. The computing device of claim 31, wherein the processor is configured with processor executable instructions to implement a slave helper application that performs processes further comprising:
receiving a notification from the second computing device that portions of a display image may be transmitted;
displaying a prompt on the display requesting a user to confirm agreement to receive portions of a display image;
determining whether the user of the second computing device confirmed agreement to receive the portion of the display image; and
accepting the hidden window object display data in the second computing device if it is determined that the user of the second computing device confirmed agreement to receive the portion of the display image.

38. The computing device of claim 37, wherein the processor is configured with processor executable instructions to implement a slave helper application that performs processes further comprising notifying the second computing device that portions of a display image will be accepted if it is determined that the user of the second computing device confirmed agreement to receive the portion of the display image.

39. A communication system, comprising:
a first communication device; and
a second communication device,
wherein the first communication device comprises:
a first processor;
a memory coupled to the first processor and configured to include a first frame buffer; and
a first transceiver coupled to the first processor,
wherein the first processor is configured with processor executable instructions to implement a master helper application that performs processes comprising:
storing a display image generated by an application running on the first processor to the first frame buffer in the first memory as a hidden window object; and
transmitting the hidden window object display data to the second computing device via the first transceiver, and
wherein the second communication device comprises:
a second processor;
a second memory coupled to the second processor and configured to include a second frame buffer;
a second display coupled to the second processor and to the second frame buffer; and
a second transceiver coupled to the second processor,
wherein the second processor is configured with processor executable instructions to implement a slave helper application that performs processes comprising:
receiving hidden window object display data from the first computing device via the second transceiver;
storing the hidden window object display data in the second frame buffer; and
rendering an image on the second display using the hidden window object display data stored in the second frame buffer.

40. The communication system of claim 39, wherein the first processor is configured with processor executable instructions to implement a master helper application that performs processes further comprising:
directing an application running on the first processor to paint a portion of the application's display image to the first frame buffer as a hidden window object.

41. The communication system of claim 40, wherein the first processor is configured with processor executable instructions to implement a master helper application that performs processes comprising reformatting the hidden window object display data to fit the second display of the second computing device, and
wherein the first processor is configured with processor executable instructions such that transmitting the hidden window object display data to the second computing device comprises transmitting reformatted hidden window object display data to the second computing device.

42. The communication system of claim 40, wherein the second processor is configured with processor executable instructions to implement a slave helper application that performs processes further comprising:
reformatting the received hidden window object display data to fit the second display.

43. The communication system of claim 40, further comprising a third computing device, the third computing device comprising:
a third processor;
a third memory coupled to the processor; and
a third transceiver coupled to the third processor,
wherein the third processor is configured with processor executable instructions to perform processes comprising:
receiving the hidden window object display data from the first computing device;
reformatting the received hidden window object display data to fit the second display of the second computing device; and
transmitting the reformatted hidden window object display data to the second computing device to the second computing device via the third transceiver,
wherein:
the first processor is configured with first processor executable instructions such that transmitting the hidden window object display data to the second computing device via the first transceiver comprises transmitting the hidden window object display data to the third computing device for processing; and
the second processor is configured with processor executable instructions such that receiving hidden window object display data from the first computing device via the second transceiver comprises receiving the hidden window object display data via the third computing device.

44. The communication system of claim 40, wherein the first and second transceivers are wireless transceivers.

45. The communication system of claim 44, wherein the first and second transceivers are Bluetooth®t transceivers.

46. The communication system of claim 40, wherein the first processor is configured with processor executable instructions to implement a master helper application that performs processes further comprising:
receiving a user input indicating a selection of the display image to be displayed on the second computing device;
directing an application running on the first processor to paint the indicated selected portion of the application's display image to the first frame buffer as a hidden window object.

47. The communication system of claim 40, wherein:
the second processor is configured with processor executable instructions to implement a slave helper application that performs processes further comprising:
receiving a user input; and
communicating information regarding the received user input to the first computing device via the second transceiver; and
the first processor is configured with processor executable instructions to implement a master helper application that perform processes further comprising:
receiving the information regarding the received user input via the first transceiver;
correlating the received information regarding the received user input to the portion of the application's display image to determine a corresponding user input to the application operating on the first processor; and
communicating the corresponding user input to the application operating on the first processor.

48. The communication system of claim 40,
wherein the first processor is configured with processor executable instructions to implement a master helper application that performs processes further comprising notifying the second computing device that portions of a display image may be transmitted to it, and
wherein the second processor is configured with processor executable instructions to implement a slave helper application that performs processes further comprising:
prompting a user of the second computing device to confirm agreement to receive the portion of the display image;
receiving a user input;
determining whether the received user input confirmed agreement to receive the portion of the display image; and
accepting the hidden window object display data if it is determined that the user input confirmed agreement to receive the portion of the display image.

49. The communication system of claim of claim 48, wherein the second processor is configured with processor executable instructions to implement a slave helper application that performs processes further comprising transmitting a notice to the first computing device that portions of a display image will be accepted if it is determined that the user input confirmed agreement to receive the portion of the display image.

50. The communication system of claim 40, wherein the first processor is configured with processor executable instructions to implement a master helper application that performs processes further comprising:
providing characteristics of the second display of the second computing device to the application running on the first processor; and
receiving a display image from the application into the first frame buffer in a format compatible with the second display of the second computing device.

51. The communication system of claim 50, wherein display image received from the application is sized for the second display in a format that is larger than suitable for a display of the first computing device.

52. The communication system of claim 40, further comprising a fourth communication device, the fourth communication device comprising:
a fourth processor;
a fourth memory coupled to the fourth processor and configured to include a fourth frame buffer;
a fourth display coupled to the fourth processor and to the fourth frame buffer; and
a fourth transceiver coupled to the fourth processor,
wherein the second processor is configured with processor executable instructions to implement a slave helper application that performs processes further comprising transmitting the hidden window object display data to the fourth computing device via the second transceiver, and
wherein the fourth processor is configured with processor executable instructions to perform processes comprising:
receiving the hidden window object display data via the fourth transceiver;
storing the received hidden window object display data in the fourth frame buffer; and
rendering a display on the fourth display using the hidden window object display data stored in the fourth frame buffer.

53. A computing device, comprising:
means for reformatting a display image generated by an application running on the computing device to fit a display of a second computing device;
means for storing the reformatted display image in a frame buffer as a hidden window object; and
means for transmitting the hidden window object display data to the second computing device via the transceiver.

54. The computing device of claim 53, wherein means for reformatting a display image generated by an application running on the computing device comprises:
means for directing an application running on the processor to paint a portion of the application's display image to the frame buffer as a hidden window object; and
means for reformatting the hidden window object display data to fit the display of the second computing device.

55. The computing device of claim 54, wherein means for transmitting the hidden window object display data to the second computing device comprises means for transmitting reformatted hidden window object display data to the second computing device.

56. The computing device of claim 54, wherein means for transmitting the hidden window object display data to the second computing device comprises means for transmitting the original sized hidden window object display data to the second computing device.

57. The computing device of claim 54, further comprising means for receiving display data from the second computing device,
wherein means for reformatting the hidden window object display data to fit a display of the second computing device comprises means for generating a blend of the hidden window object display data and the received second computing device display data to generate a single blended display image compatible with the display of the second computing device.

58. The computing device of claim 54, further comprising means for receiving display data from the second computing device,
wherein means for reformatting the hidden window object display data to fit a display of the second computing device comprises means for generating a single display image compatible with the display of the second computing device that presents the hidden window object display data side-by-side with the received second computing device display data.

59. The computing device of claim 53, wherein means for transmitting the hidden window object display data to the second computing device comprises means for transmitting the hidden window object display data to the second computing device via a wireless data link established between with the second computing device.

60. The computing device of claim 53, further comprising means for receiving a user input indicating a selection of the display image to be displayed on the second computing device,
wherein means for reformatting a display image to fit a display of the second computing device comprises:
means for directing an application running on the processor to paint the indicated selected portion of the display image to the frame buffer as a hidden window object; and
means for reformatting the hidden window object display data to fit the display of the second computing device.

61. The computing device of claim 53, further comprising:
means for receiving information regarding a user input from the second computing device;
means for correlating the information regarding the user input to the portion of the application's display image to determine a corresponding user input to the application operating on the computing device; and
means for communicating the corresponding user input to the application operating on the computing device.

62. The computing device of claim 53, further comprising means for notifying the second computing device that portions of a display image may be transmitted to it.

63. The computing device of claim 53, wherein means for reformatting a display image generated by an application running on the computing device to fit a display of the second computing device comprises:
means for providing characteristics of the display of the second computing device to the application running on the computing device; and
means for receiving a display image from the application into the frame buffer in a format compatible with the display of the second computing device.

64. A computing device, comprising:
means for receiving hidden window object display data from a second computing device;
means for storing the hidden window object display data; and
means for displaying an image on a display using the hidden window object display data.

65. The computing device of claim 64, further comprising means for reformatting the hidden window object display data to fit the display.

66. The computing device of claim 65, wherein means for reformatting the hidden window object display data to fit the display comprises means for generating a blend of the hidden window object display data and display data from an application running on the computing device to generate a single blended display image.

67. The computing device of claim 65, wherein means for reformatting the hidden window object display data to fit the display comprises means for displaying an image that presents the hidden window object display data side-by-side with display data from an application running on the computing device.

68. The computing device of claim 64, wherein means for receiving the hidden window object display data from the second computing device comprises means for receiving the hidden window object display data via a wireless data link established with the second computing device.

69. The computing device of claim 64, further comprising:
means for receiving a user input; and
means for communicating information regarding the received user input to the second computing device.

70. The computing device of claim 64, further comprising:
means for receiving a notification from the second computing device that portions of a display image may be transmitted;
means for displaying a prompt requesting a user to confirm agreement to receive portions of a display image;
means for receiving a user input;
means for determining whether a received user input confirmed agreement to receive the portion of the display image; and
means for accepting the hidden window object display data in the second computing device if it is determined that the received user input confirmed agreement to receive the portion of the display image.

71. The computing device of claim 70, further comprising means for notifying the second computing device that portions of a display image will be accepted if it is determined that the received user input confirmed agreement to receive the portion of the display image.

72. A communication system, comprising:
a first communication device; and
a second communication device,
wherein the first communication device comprises:
means for storing a display image generated by an application running on the first processor to a first frame buffer as a hidden window object; and
means for transmitting the hidden window object display data to the second computing device, and
wherein the second communication device comprises:
means for receiving hidden window object display data from the first computing device;
means for storing the hidden window object display data; and
means for rendering an image using the hidden window object display data.

73. The communication system of claim 72, wherein the first computing device further comprises:
means for directing an application running on the first computing device to paint a portion of the application's display image to a frame buffer as a hidden window object; and
means for reformatting the hidden window object display data to fit a display of the second computing device.

74. The communication system of claim 72, wherein the first computing device further comprises:
means for reformatting the hidden window object display data to fit a display of the second computing device, and
wherein means for transmitting the hidden window object display data to the second computing device comprises means for transmitting reformatted hidden window object display data to the second computing device.

75. The communication system of claim 72, wherein the second processor is configured with processor executable instructions to perform processes comprising:
reformatting the received hidden window object display data to fit the second display.

76. The communication system of claim 72, further comprising a third computing device, the third computing device comprising:
means for receiving the hidden window object display data from the first computing device;
means for reformatting the received hidden window object display data to fit a display of the second computing device; and
means for transmitting the reformatted hidden window object display data to the second computing device,
wherein:
the first computing device means for transmitting the hidden window object display data to the second computing device comprises means for transmitting the hidden window object display data to the third computing device for processing; and
the second computing device means for receiving hidden window object display data from the first computing device comprises means for receiving the hidden window object display data via the third computing device.

77. The communication system of claim 72, wherein the first computing device further comprises:
means for receiving a user input indicating a selection of the display image to be displayed on the second computing device;
means for directing an application running on the first processor to paint the indicated selected portion of the application's display image to a frame buffer as a hidden window object; and
means for reformatting the hidden window object display data to fit a display of the second computing device.

78. The communication system of claim 72, wherein:
the second computing device further comprises:
means for receiving a user input; and
means for communicating information regarding the received user input to the first computing device; and
the first computing device further comprises:
means for receiving the information regarding the received user input;
means for correlating the received information regarding the received user input to the portion of the application's display image to determine a corresponding user input to the application operating on the first computing device; and
means for communicating the corresponding user input to the application operating on the first computing.

79. The communication system of claim 72,
wherein the first computing device further comprises means for notifying the second computing device that portions of a display image may be transmitted to it, and
wherein the second computing device further comprises:
means for prompting a user of the second computing device to confirm agreement to receive the portion of the display image;
means for receiving a user input;
means for determining whether the received user input confirmed agreement to receive the portion of the display image; and
means for accepting the hidden window object display data if it is determined that the user input confirmed agreement to receive the portion of the display image.

80. The communication system of claim of claim 79, wherein the second computing device further comprises means for transmitting a notice to the first computing device that portions of a display image will be accepted if it is determined that the user input confirmed agreement to receive the portion of the display image.

81. The communication system of claim 72, wherein the first computing device further comprises:
means for providing characteristics of a display of the second computing device to the application running on the first computing device; and
means for receiving a display image from the application into a frame buffer in a format compatible with the display of the second computing device.

82. The communication system of claim 72, further comprising a fourth communication device,
wherein the second computing device further comprises means for transmitting the hidden window object display data to the fourth computing device, and
wherein the fourth communication device comprises:
means for receiving the hidden window object display data from the second computing device;
means for storing the received hidden window object display data; and
means for rendering a display using the hidden window object display data.

83. A computer program product, comprising:
a computer-readable storage medium comprising:
at least one instruction for reformatting a display image generated by an application running on the computing device to fit a display of a second computing device and storing the reformatted display image to a frame buffer in memory as a hidden window object under direction of the master helper application; and
at least one instruction for transmitting the hidden window object display data to the second computing device via the transceiver.

84. The computer program product of claim 83, wherein the at least one instruction for reformatting a display image generated by an application running on the computing device to fit a display of a second computing device and storing the reformatted display image to a frame buffer in memory device as a hidden window object under direction of the master helper application comprises:
at least one instruction for directing an application to paint a portion of the application's display image to the frame buffer as a hidden window object; and
at least one instruction for reformatting the hidden window object display data to fit the display of the second computing device.

85. The computer program product of claim 84, wherein the at least one instruction for transmitting the hidden window object display data to the second computing device comprises at least one instruction for transmitting reformatted hidden window object display data to the second computing device.

86. The computer program product of claim 84, wherein the at least one instruction for transmitting the hidden window object display data to the second computing device comprises at least one instruction for transmitting the original sized hidden window object display data to the second computing device.

87. The computer program product of claim 84, wherein the computer-readable storage medium further comprises at least one instruction for receiving display data from the second computing device, wherein the at least one instruction for reformatting the hidden window object display data to fit a display of the second computing device under direction of the master helper application comprises at least one instruction for generating a blend of the hidden window object display data and the received second computing device display data to generate a single blended display image compatible with the display of the second computing device.

88. The computer program product of claim 84, wherein the computer-readable storage medium further comprises at least one instruction for receiving display data from the second computing device,
wherein the at least one instruction for reformatting the hidden window object display data to fit a display of the second computing device under direction of the master helper application comprises at least one instruction for generating a single display image compatible with the display device of the second computing device that presents the hidden window object display data side-by-side with the received second computing device display data.

89. The computer program product of claim 83, wherein the at least one instruction for transmitting the hidden window object display data to the second computing device comprises at least one instruction for transmitting the hidden window object display data to the second computing device via a wireless data link established with the second computing device.

90. The computer program product of claim 83, wherein the computer-readable storage medium further comprises at least one instruction for receiving a user input indicating a selection of the display image to be displayed on the second computing device,
wherein the at least one instruction for reformatting a display image to fit a display of the second computing device and storing the reformatted display image to the frame buffer as a hidden window object under direction of the master helper application comprises:
at least one instruction for directing an application to paint the indicated selected portion of the display image to the frame buffer as a hidden window object; and
at least one instruction for reformatting the hidden window object display data to fit the display of the second computing device.

91. The computer program product of claim 83, wherein the computer-readable storage medium further comprises:
at least one instruction for receiving information regarding a user input from the second computing device;
at least one instruction for correlating the information regarding the user input to the portion of the application's display image to determine a corresponding user input to the application; and
at least one instruction for communicating the corresponding user input to the application.

92. The computer program product of claim 83, wherein the computer-readable storage medium further comprises at least one instruction for notifying the second computing device that portions of the display image may be transmitted to it.

93. The computer program product of claim 83, wherein the at least one instruction for reformatting a display image generated by an application to fit a display of the second computing device and storing the reformatted display image to the frame buffer as a hidden window object under direction of the master helper application comprises:
at least one instruction for providing characteristics of the display of the second computing device to the application; and
at least one instruction for receiving a display image from the application into the frame buffer in a format compatible with the display of the second computing device.

94. A computer program product, comprising:
a computer-readable storage medium comprising:
at least one instruction for receiving hidden window object display data from a second computing device;
at least one instruction for storing the hidden window object display data under direction of the slave helper application; and
at least one instruction for displaying an image using the hidden window object display data.

95. The computer program product of claim 94, wherein the computer-readable storage medium further comprises at least one instruction for reformatting the hidden window object display data to fit a display under direction of the slave helper application.

96. The computer program product of claim 95, wherein the at least one instruction for reformatting the hidden window object display data to fit the display under direction of the slave helper application comprises at least one instruction for generating a blend of the hidden window object display data and display data from another application to generate a single blended display image.

97. The computer program product of claim 95, wherein the at least one instruction for reformatting the hidden window object display data to fit the display under direction of the slave helper application comprises at least one instruction for displaying an image that presents the hidden window object display data side-by-side with display data from another application.

98. The computer program product of claim 94, wherein the at least one instruction for receiving the hidden window object display data from the second computing device comprises at least one instruction for receiving the hidden window object display data via a wireless data link established with the second computing device.

99. The computer program product of claim 94, further comprising:
at least one instruction for receiving a user input; and
at least one instruction for communicating information regarding the received user input to the second computing device.

100. The computer program product of claim 94, further comprising:
at least one instruction for receiving a notification from the second computing device that portions of a display image may be transmitted;
at least one instruction for displaying a prompt requesting a user to confirm agreement to receive portions of a display image;
at least one instruction for receiving a user input;
at least one instruction for determining whether the user input confirmed agreement to receive the portion of the display image; and
at least one instruction for accepting the hidden window object display data in the second computing device if it is determined that the user of the second computing device confirmed agreement to receive the portion of the display image.

101. The computer program product of claim 100, wherein the computer-readable storage medium further comprises at least one instruction for notifying the second computing device that portions of a display image will be accepted if it is determined that the user of the second computing device confirmed agreement to receive the portion of the display image.
